(19) United States
(12) Patent Application Publication
(10) Pub. No.: US 2007/0161382 A1
(43) Pub. Date: Jul. 12, 2007

(54) SYSTEM AND METHOD INCLUDING ASYNCHRONOUS LOCATION-BASED MESSAGING

(76) Inventors: Daniel J. Melinger, New York, NY (US); Eyal Michael Sharon, Brooklyn, NY (US)

Correspondence Address: PILLSBURY WINTHROP SHAW PITTMAN, LLP, P.O. BOX 10500, MCLEAN, VA, 22102, US

(21) Appl. No.: 11/621,391

(22) Filed: Jan. 9, 2007

Related U.S. Application Data
(60) Provisional application No. 60/757,274, filed on Jan. 9, 2006.

(51) Int. Cl. H04Q 7/20; G06F 15/16

(52) U.S. Cl. 455/456.1; 709/206; 709/217

(57) ABSTRACT

A system and method including asynchronous location-based messaging is provided. Multimedia content may be created and associated with a specific geographic location. Notification messages associated with location-based content may be designated for receipt by particular users, for example, when the users are located within a predetermined distance of the geographic location. The notification messages, which may be transmitted to users' mobile computing devices, may include information about, as well as a pointer to, the location-based content to enable the content to be accessed immediately or at a later time through any number of interfaces.

### CROSS-REFERENCE TO RELATED APPLICATIONS

This Application claims priority to U.S. Provisional Patent Application Ser. No. 60/757,274, filed Jan. 9, 2006, which is incorporated herein by reference in its entirety.

### FIELD OF THE INVENTION

The invention relates generally to location-based messaging, and more particularly to a system and method including asynchronous location-based messaging, wherein content may be created and associated with a specific geographic location. Notification messages associated with location-based content may be designated for receipt by particular users, for example, when the users are located within a predetermined distance of the geographic location. The notification messages, which may be transmitted to users' mobile computing devices, may include information about, as well as a pointer to, the location-based content to enable the content to be accessed immediately or at a later time through any number of interfaces.

### BACKGROUND OF THE INVENTION

Social network technologies claim to map virtual connections between friends. Web-based social networks represent one of the most common types of social network applications used today. While web sites built upon social networks can be fun and interesting to browse, users may lose interest quickly if there is no direct way to correlate the virtual or artificial social network with its real world counterpart. For example, social network data, which generally comprises information about connections between people, is quite useful to members of a social network when they are mobile, as this is when they are most likely to find themselves in close proximity to people within their network. Unfortunately, most web-based social networks are difficult to explore in actual social situations (e.g., at a bar, at the park, at the movies, etc.) when they should provide greater value.

Attempts at overcoming the various drawbacks associated with web-based social network applications have focused on mobile computing devices. Mobile telephones, for example, are near ubiquitous computing devices. Due to the proliferation of these devices, a growing number of people throughout the world have access to people and information around the world at virtually anytime, and anywhere. Since mobile telephones are widely deployed, have powerful microprocessors, and are networked with other mobile phones and existing communication infrastructure, they can be a useful platform for connecting in ways other than through traditional voice communication. For example, because the locations of mobile computing devices can often be determined using a number of different methods, various space annotation systems have been created that enable virtual content (e.g., messages, advertisements, etc.) to be placed in specific geographical locations. This virtual content may be delivered to users carrying portable devices when the users are physically near locations associated with the content.

There are, however, drawbacks associated with existing location-based, space annotation systems. For example, one limitation of existing systems is that content designated for a specific geographical location may be delivered to anyone using the system who is located within a predetermined distance of the specific geographical location. This may often result in a multitude of unwanted and potentially inappropriate media being delivered to a user of the system, serving to waste the user's time, use unnecessary and costly bandwidth, and to make the media difficult for the user to organize and manage.

Additionally, while most people have a need and desire to learn more about the locations they visit, it is often not desirable that location-based content be consumed only at the times when people are actually at a specific location associated with the content. This may be especially true, for instance, when a user is operating a motor vehicle and distractions can be dangerous. This is also true, however, in those instances when a user is busy, or when the content is considered entertainment and the person is conducting business, or when consumption of the location-based content is better accomplished using a tool to which the user may not currently have access (e.g., consumption may be better accomplished using a computer with a large monitor when a user is only carrying a mobile telephone).

These and other drawbacks exist with existing location-based, space annotation systems.

### SUMMARY OF THE INVENTION

The invention addressing these and other drawbacks relates to a social networking system and method that accounts for people's need to communicate with specified individuals and/or groups of individuals in both synchronous and asynchronous manners. Often, people may wish to communicate something to someone (maybe not necessarily a specific person) at a particular place, or at a distinct time. For example, an individual may wish to comment upon a beautiful example of architecture. While it may not be important who, specifically, the individual communicates with, it will more often than not be with someone to whom the individual is connected socially, or with someone sharing a common interest (e.g., someone interested in architectural critique). It may also be beneficial to communicate with other individuals when they are in close physical proximity to the architectural example. Thus, the communication may be tied to both a place, and to an individual or to groups of individuals. This invention provides for such communication.

According to an aspect of the invention, a user may create, receive, and explore location-based content via one or more interfaces such as, for example, a mobile phone application, a mobile web browser, a mobile computer, a personal computer web browser, a personal computer application, a public video screen display, a television, an Interactive Voice Response (IVR) system, or other interface.

In one implementation, a user may wish to create and/or compile content to be associated with a specific geographic location. The content may relate to any person, people, building, structure, landmark, natural occurring phenomenon, or any other type of other object or entity at a specific geographic location. To identify a location, a user may specify location identifier data including, but not limited to, any one or more of coordinates (latitude and longitude), a street address, an intersection, a zip code, or other location identifier data. The user may then create and/or compile the content to be associated with the specified geographic location. Examples of content may include, for instance, any one or more of text, audio, images, video, or other media. The location identifier data and the created and/or compiled content may then be associated in a location-based message (or virtual “sticky note”).

In one implementation, a user may also define one or more parameters to be associated with a location-based message they create. For example, a user may designate certain recipients or groups of recipients that will be authorized to receive or otherwise access a location-based message that he or she has created. A user may also define parameters relating to the geographic reach of a location-based message. For example, the user may specify the size of a geographic area (typically measured in relation to the specific geographic location associated with the content) within which the location-based message will be made available. The region may be of any size or dimension. Users may additionally define timing and availability parameters relating to when, and for how long, a location-based message may be made available to authorized recipients. Other location-based message parameters may be specified.

Enabling users to create location-based messages facilitates social networking, in one regard, by enabling users to annotate the space around them by creating content that may be accessed at a time and/or place when it is most relevant to themselves or others.

According to an aspect of the invention, users of the system of the invention may be notified of the existence of relevant location-based messages around them, as they travel from place to place, based on the determined location of their mobile computing device (e.g., their mobile phone). The location of a user's mobile computing device may be determined via any number of location-tracking methods including, but not limited to, Bluetooth beacons, the Global Positioning System (GPS), analysis of wireless network antennae utilization, physical hyperlink technologies such as two-dimensional barcodes or Radio Frequency identification (RFID) tags, or wireless network antenna triangulation.

Based in part on a user's determined location, various algorithms may be used to identify location-based messages that may be available for the user. In addition to location, the identification of relevant location-based messages may also be based on one or more filtering criteria including, but not limited to, the identity of the user, the current local time at the determined location, parameters associated with location-based messages as defined by their creators (e.g., designated recipients, geographic reach, timing and availability information, etc.), social relevance to the user (as determined, for instance, by any number of different filtering criteria); the status of location-based messages (e.g., active, expired, etc.); historical usage of the system by the user; or other criteria or information.

According to an aspect of the invention, if a location-based message is deemed to be available to a user, a notification message may be transmitted to the user's mobile computing device. The notification message may include information about the location-based message (e.g., the message's creator, the title and/or subject matter of the message, etc.), as well as a pointer to the location-based message. Based on the information included in the notification message, a user may elect to access the content in the location-based message immediately, at a later time through any number of interfaces, or to disregard the location-based message entirely.

Notification messages are advantageous in that they enable information about location-based messages to be viewed before the full media content of the messages is retrieved. This aids in the prevention of the unnecessary use of often costly wireless and wired network bandwidth. It also enables users to comfortably receive information about a larger quantity of location-based messages than the quantity of messages for which the user may actually wish to receive associated content.

According to one implementation of the invention, users, third-party publishers, or other individuals or entities may create and moderate a topic-centric body of location-based content which may be referred to herein as a “channel.” Users that subscribe to channels may receive notification messages on their mobile computing devices when they are within a predetermined distance of a specific geographic location for which topical location-based content has been created. Users may access the location-based messages associated with the notification messages immediately, or at a later time (if at all). Various types of channels may exist including, for example, “public” channels accessible by any user interested in the particular topic of the location-based content of the channel. Other channels may be restricted to only those users invited (or accepted) by the creator of the channel. Still other channels may be created requiring users to pay to access the location-based content of the channel. Other variations exist.

According to an aspect of the invention, various interfaces may be used, at any time, to enable users to filter and view location-based content according to any number of different criteria. Location-based messages may be browsed and viewed, for example, by geographical location, by content creator or content subject, by channel, by content rating, by a user rating, by altitude, or via any number of other filtering criteria. Enabling messages to be consumed in various formats, through various interfaces, and at various times enables users to browse and search through location-based messages in various ways that allow for more effective consumption of the media. As but one example, by maintaining a usefully structured record of location-based messages, the invention may enable users to view their own, or some other user's, history of location-based messages in order to recall where the user traveled in the past, or to find some location-based content that had been retrieved via a message in the past.

An additional advantage provided by the system and method of the invention is the ability for users to provide feedback on the content of location-based messages. Feedback may be provided in various forms, including as comments, ratings, the tagging or identification of location-based messages as “favorites,” blog-style follow-up posting, etc. In this regard, a location-based message may become more than just a static piece of information. It may become a dynamic piece of content that may evolve over time (as feedback is added), and become the focal point of a “virtual conversation” among users. All types of feedback, whether positive or negative, may ultimately aid in the creation of richer, more meaningful communication among those users communicating and consuming the content (for example, members of a particular social network).

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### DESCRIPTION OF THE DRAWINGS

FIG. 1 is an exemplary schematic representation of aspects of the invention, in one

FIG. 2A is a schematic diagram of a system, according to an aspect of the invention.

FIG. 2B is a schematic diagram of an application, according to an aspect of the invention.

FIG. 3 is an exemplary illustration of a view that may be presented to a user during a registration process, according to an aspect of the invention.

FIG. 4 is an exemplary illustration of a profile view that may be presented to a user, according to an aspect of the invention.

FIG. 5 is an exemplary illustration of a view that may be presented to a user, according to an aspect of the invention.

FIG. 6 is an exemplary illustration of a view that may be presented to a user, according to an aspect of the invention.

FIG. 7 illustrates a flowchart of processing for content creation, according to an aspect of the invention.

FIGS. 8A-8C are exemplary illustrations of views that may be presented to a user while creating a location-based message, according to an aspect of the invention.

FIG. 9 is an exemplary illustration of a view that may be presented to a user, according to an aspect of the invention.

FIGS. 10A-10C are exemplary illustrations of views that may be presented to a user, according to an aspect of the invention.

FIGS. 11A-11B are exemplary illustrations of views that may be presented to a user while creating a channel, according to an aspect of the invention.

FIG. 12 illustrates a flowchart of processing for locating and notifying users of the availability of location-based content, according to an aspect of the invention.

FIG. 13 is an exemplary illustration of a location-based message displayed on a mobile computing unit, according to an aspect of the invention.

FIG. 14 is an exemplary illustration of a location-based message displayed on a mobile computing unit, according to an aspect of the invention.

FIGS. 15A-15C are exemplary illustrations of views that may be presented to a user while exploring location-based content, according to an aspect of the invention.

### DETAILED DESCRIPTION OF THE INVENTION

The invention described herein is directed to a system and method including asynchronous location-based messaging. Table 1 categorizes methods for both electronic and traditional modes of communication within time-dependent (asynchronous or synchronous) and location-dependent (location-independent or location-based) modes. Synchronous communication generally refers to communication wherein composition of media and receipt of the media occur at nearly the same time. With asynchronous communication, by contrast, receipt of the media can occur at any time after composition.

Location-based communications are communications that may be tied to a specific geographical location, while location-independent communications are not tied to any particular location. The modes of communication may be further categorized according to whether they are suited for interpersonal (e.g., between individuals) or broadcast (e.g., for general consumption) media delivery. With reference to Table 1, examples of modes suited for broadcast are printed within parentheses. The invention as described herein, as noted in Table 1, may be asynchronous, location-based, and interpersonal.

TABLE 1
Comparison of Communication Modes.

| | LOCATION- | |
|---|---|---|
| | INDEPENDENT | LOCATION-BASED |
| SYNCHRONOUS | Telephone | In-person Conversation |
| | (Television) | (Lecture) |
| ASYNCHRONOUS | Electronic Mail | INVENTION |
| | (Newspaper) | (Space Annotation Systems) |

In the non-virtual realm, people create their own filters on the communications they receive, often based on their social networks and the subjects in which they are interested. As an example, people talk more often to those with whom they are friends or business associates. Moreover, in the non-virtual realm, people obtain information regarding the subjects about which they are interested by reading special-purpose magazines rather than by browsing through large quantities of general-purpose publications in order to find articles of personal interest. One can limit their virtual communications to interesting topics, for instance, by subscribing to topic-specific email-lists, and by browsing websites of interest to them.

This invention enables content to be created and associated with a specific geographic location. The invention further enables notification messages associated with location-based content to be designated for receipt by particular users, for example, when the users are located within a predetermined distance of the geographic location. In one implementation, notification messages associated with location-based content may be added to a queue for a user upon detection of the user's mobile computing device within a predetermined geographic area. The notification messages, which may be transmitted to a user's mobile computing device, may include information about, as well as a pointer to, the location-based content to enable the content to be accessed immediately or at a later time through any number of interfaces. Accordingly, as noted above with regard to Table 1, the invention is advantageous in that it may be asynchronous, location-based, and interpersonal.

Overview

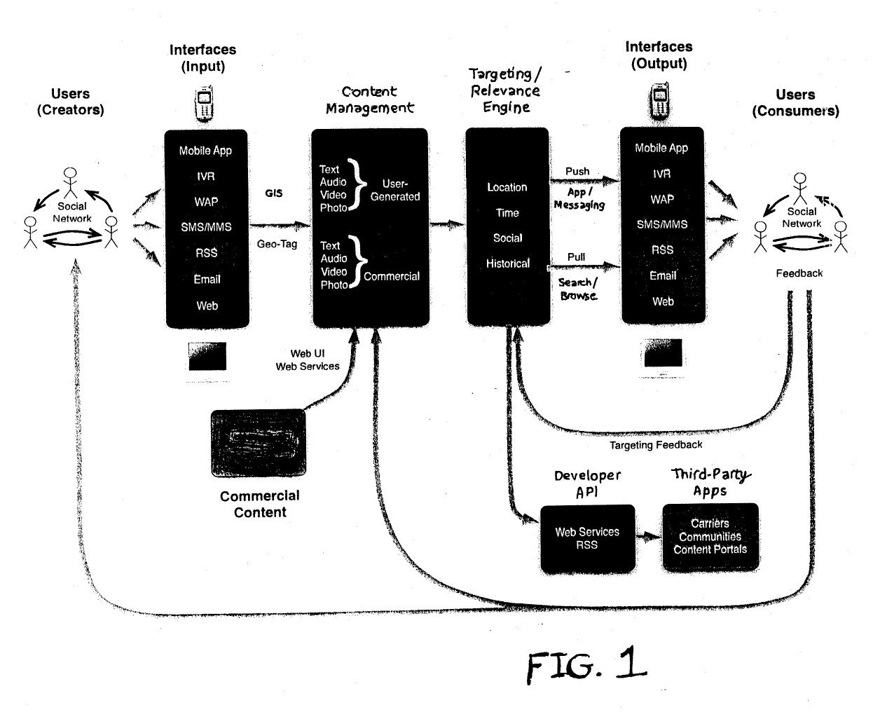

As a general overview, FIG. 1 provides an exemplary schematic representation of aspects of the invention, in one regard. These aspects, along with additional features and functionality, will be discussed in greater detail below (and with reference to the remaining accompanying drawing figures).

As shown in FIG. 1, any number of users may utilize any number of interfaces to create content, associate the content with a specific geographic location, and provide the location-based (or “geo-tagged”) content to a system for, among other things, storage and/or management.

In some implementations, location-based content may also be created and/or provided by private entities (e.g., event guide publishers, marketing agencies, travel agents, hotel chains, professional sports teams, restaurants, concert promoters, etc.), public entities (e.g., local, state, and federal governments, etc.), and/or other individuals or entities.

According to an aspect of the invention, location-based content received from users and other entities may comprise multimedia location-based messages that include one or more of, for example, text, audio, images, video, or any combination thereof. Location-based messages may also be referred to herein as virtual “sticky notes,” “sticky shadows,” or “stickies.”

In one implementation, a creator of a location-based message may specify, among other parameters, designated recipients or groups of recipients authorized to have access to the location-based message, the size of a geographic area (typically measured in relation to the specific geographic location associated with the content) within which the location-based message may be made available, timing and availability information as to when and for how long the location-based message may be made available to the authorized recipients, or other parameters.

Although a user may be eligible to access any number of particular location-based messages (or virtual “sticky notes”), he or she may be made aware of the existence of select location-based messages based on a number of factors including, but not limited to, the user's current location (e.g., is he or she within a predetermined geographic area), the time of day, social relevance (as determined, for instance, by any number of different filtering criteria), message status (e.g., active, expired, etc.), historical usage of the system by the user, or other factors.

According to an aspect of the invention, relevant or targeted location-based messages may be consumed by users in any number of ways (e.g., using “push” or “pull” technology) via any number of interfaces.

In one example, a notification message associated with a location-based message (or virtual “sticky note”) may be added to a queue for a user upon detection of the user's mobile computing device within a predetermined geographic area. The notification message, which may be transmitted to the user's mobile computing device, may include information about the location-based message (e.g., the message's creator, the title and/or subject matter of the message, etc.), as well as a pointer to the location-based message. Based on the information included in the notification message, the user may elect to access the content in the location-based message immediately, at a later time through any number of interfaces, or to disregard the location-based message entirely.

Notification messages are advantageous in that they enable information about location-based messages to be viewed before the full media content of the messages is retrieved. This aids in the prevention of the unnecessary use of often costly wireless and wired network bandwidth. It also enables users to comfortably receive information about a larger quantity of location-based messages than the quantity of messages for which the user may actually wish to receive associated content. Despite the benefits associated with the use of notification messages, it should be recognized that, in any implementations described herein, the actual location-based messages may be transmitted to users' mobile computing devices.

In one implementation, and as will be described in greater detail below, the system may maintain an organized history of notification messages made available to users. These notification messages may be consumed through various formats and through various interfaces, and filtered according to various criteria. This enables users to browse and search through notification messages in various ways that allow for more effective consumption of the media. While organizing and managing notification messages (rather than the location-based messages themselves) is advantageous in that it enables information about location-based messages to be viewed before the full media content of the location-based messages is retrieved, it should be recognized that, in any implementations described herein, the actual location-based messages may be organized and managed.

According to an aspect of the invention, user feedback pertaining to location-based messages may be provided in a variety of ways. Data on consumption of location-based messages may be acquired, for example, in a historical usage data record and analyzed in order to refine (and enhance) future selection of content for users.

Feedback on the content of location-based messages may also be provided in the form of comments, ratings, the tagging or identification of location-based messages as “favorites,” blog-style follow-up posting, etc. In this regard, a location-based message may become more than just a static piece of information. It may become a dynamic piece of content that may evolve over time (as feedback is added), and become the focal point of a “virtual conversation” among users.

Another form of feedback regarding location-based messages may comprise direct feedback to a creator of a location-based message. A recipient may provide feedback on any aspect of a location-based message directly to the message creator via an in-person communication, telephone communication, electronic (e.g., e-mail, instant message, etc.) communication, or other type of communication. All types of feedback, whether positive or negative, may ultimately aid in the creation of richer, more meaningful communication among those users communicating and consuming the content (for example, members of a particular social network).

As illustrated in FIG. 1, in certain implementations, an Application Program Interface (API) may be made available to enable third-party developers to create complimentary applications.

System Architecture

Prior to providing a more detailed description of the various features and functionality described above (with reference to FIG. 1), an exemplary system architecture, according to an aspect of the invention, will first be described.

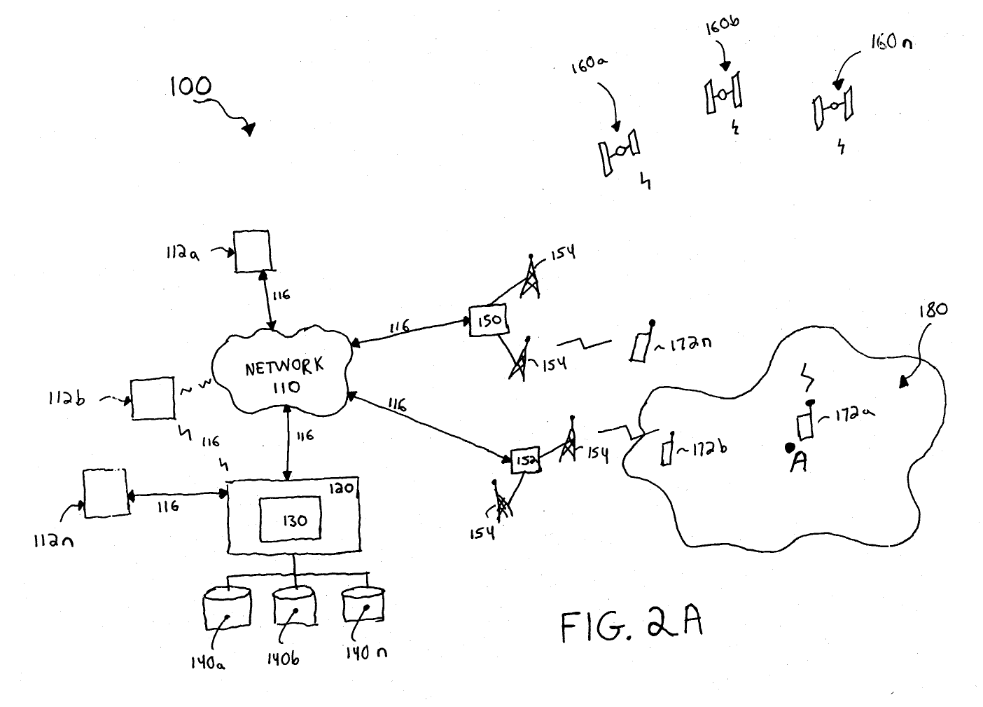

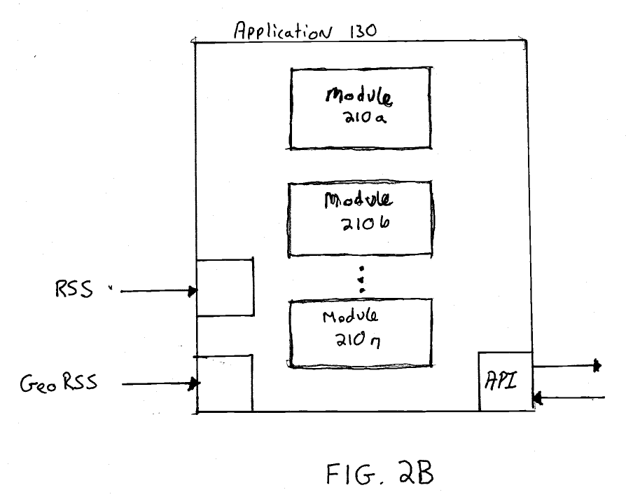

As illustrated in FIG. 2A, system 100 may include a server 120 which may be or include, for instance, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep™, or other operating system or platform. In some implementations, one or more servers 120 may be provided.

According to aspect of the invention, server 120 may host an application 130. Application 130 may comprise an Internet web site, an intranet site, or other host site or application maintained by a service provider, or other entity. Application 130 may be accessed by users desirous of creating, managing, and/or exploring multimedia content that has been associated with specific geographical locations.

As illustrated in FIG. 2B, those having skill in the art will recognize that application 130 may comprise any number of software modules (210a, 210b, . . . 210n), each of which may implement one or more of the various features and functions described in detail herein. Non-limiting examples of modules (210a, 210b, . . . 210n) may include a user registration module, financial transaction module, user profile module, delivery settings module, contacts module, content creation module, content targeting module, display module, search module, channel module, location determination module, or other modules. One or more of the modules comprising application 130 may be combined. For some purposes, not all modules may be necessary. As noted above with regard to FIG. 1, an API may be provided to enable third-party developers to create complimentary applications, and to enable content exchange. In some implementations, described in greater detail below, application 130 may receive content via an RSS feed as well as a GeoRSS feed. GeoRSS is a standard for encoding geographical information into feeds of content. Some examples of available GeoRSS feeds include feeds from web sites such as Yelp, BlockRocker, and Flickr.

Referring back to FIG. 2A, one or more databases (140a, 140b, . . . 140n) may be operatively connected to server 120. Databases (140a, 140b, . . . 140n) may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Query Language), a SAN (storage area network), Microsoft Access™ or others may also be used, incorporated, or accessed. Databases (140a, 140b . . . 140n) may store any type of data including, but not limited to, user profile/account information, location-based content, usage history data, location-based advertisements, financial data, or any other type of data.

According to an aspect of the invention, users may access server 120 and application 130 via any number of client devices (112a, 112b, . . . 112n) and/or mobile computing devices (172a, 172b, . . . 172n).

Client devices (112a, 112b, . . . 112n), which may include (but are not limited to) workstations, personal computers, laptop computers, or other client devices, may be networked directly to server 120, or connected to server 120 over a network 110, via a wired or wireless communications link 116.

Network 110 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), or other network. Any suitable communications link 116 may be utilized, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, wireless connection, or other connection.

In operation, users of client devices (112a, 112b, . . . 112n) may access server 120 and application 130 through an interface. By way of example, server 120 may comprise a web server and the interface may comprise a web browser. Those having skill in the art will recognize that other client/server and network configurations may be used.

According to an aspect of the invention, server 120 may be connected through network 110 to one or more communication systems including, for example, various cellular networks (150, 152). Cellular networks (150, 152) may communicate with mobile computing devices (172a, 172b, . . . 172n) through antennae on towers 154 in a known manner. Examples of mobile computing devices (172a, 172b, . . . 172n) may include, but are not limited to, portable computers, personal digital assistants (PDAs), wireless phones, web-enabled mobile phones, WAP devices, web-to-voice devices, or other wireless devices. Communications by and between server 120, cellular networks (150, 152), and mobile computing devices (172a, 172b, . . . 172n) may follow standard protocols as will be appreciated by those having skill in the art.

There are various ways by which users of mobile computing devices (172a, 172b, . . . 172n) may access and utilize one or more of the features and functionality of social networking application 130. The manner by which a user accesses application 130 may depend on the type (and capabilities) of a user's particular mobile computing device and/or his or her personal preferences. One example may include the installation of a mobile application (e.g., a Java application) on a mobile computing device. Alternatively, some mobile computing devices may have web browsers enabling access to a mobile web site (associated with application 130) using Wireless Access Protocol (WAP). As yet another example, some mobile computing devices may communicate with application 130 via Short Message Service (SMS) and/or Multimedia Message Service (MMS) transmissions. Additional options may be utilized.

According to one implementation of the invention, and as described in greater detail below, one of the factors that may determine whether a user may be made aware of the existence of a location-based message is the physical location of the user. For example, a user associated with mobile computing device 172a may create a location-based message (or virtual “sticky note”) about any item of interest located at a specific geographical location. In FIG. 2A, this specific geographical location is illustrated as a location “A.” The creator may then specify, among other parameters, that only certain users from his or her “contacts” list, for instance, may receive a notification message (corresponding to the location-based message) when they are within a certain geographical area 180 relative to location “A.” Accordingly, system 100 may utilize any number of location-tracking methods to determine the location of users' mobile computing devices (172a, 172b, . . . 172n) including, but not limited to, Bluetooth beacons, the Global Positioning System (GPS), analysis of wireless network antennae utilization, physical hyperlink technologies such as two-dimensional barcodes or Radio Frequency identification (RFID) tags, or wireless network antenna triangulation.

In one implementation, for instance, if a mobile computing device is GPS or A-GPS enabled, or is connected via Bluetooth to a GPS device (traveling along with the user), and is running a mobile application (e.g., a Java application), the application running on the mobile computing device may obtain location information (determined in a known manner from signals broadcast by any number of satellites (160a, 160b, . . . 160n)), and transmit the location information to server 120 (and application 130).

Alternatives to GPS exist. For example, a mobile computing device may query for data from a device connecting to an alternative satellite constellation (e.g., Galileo), or may query for location information from a server-based system (e.g., Loki™, which is provided by Skyhook Wireless, Inc.).

In yet another implementation, if a user is accessing application 130 through a web or mobile web browser, or via text messaging (e.g., SMS), location may be obtained through communications between server 120 and a third-party location server such as one hosted by, or on behalf of, a mobile service provider.

As yet an additional example, Bluetooth beacons may determine the location of a mobile computing device. When a mobile computing device enters an area with a beacon, the device scans the area, retrieves geographic positioning data from the beacon, and then transmits its position to server 120 (and application 130) via General Packet Radio Service (GPRS).

In yet another example, location-based readers such as Radio Frequency Identification (RFID) readers may be utilized to locate an RFID tag carried with a person and transmit geographic positioning data to server 120 (and application 130) over a network (e.g., the Internet).

In one implementation, a user may manually provide his or her location (e.g., as a street address, intersection, zip code, etc.) to application 130 via any number of interfaces. Application 130 may then convert the received data into coordinates (latitude and longitude) using one or more processing algorithms.

Other known or hereafter developed location-tracking technology may be utilized. As described in detail below, various algorithms may be utilized to determine how often the location of users' mobile computing devices (172a, 172b, . . . 172n) should be identified.

Although not illustrated, server 120 may also host or interface to an Interactive Voice Response (IVR) system. The IVR system may provide an interface by which users can create, manage, and/or explore multimedia content that has been associated with specific geographical locations.

Those having skill in the art will appreciate that the invention described herein may work with various system configurations. Accordingly, more or less of the aforementioned system components may be used and/or combined in various implementations.

Having provided an overview of aspects of the system (FIG. 1) of the invention, as well as an explanation of the one or more components that may comprise an exemplary architecture (FIG. 2A) of system 100, the various features and functionality of the invention will now be described in further detail with reference, in some instances, to various views illustrated in the accompanying drawing figures.

Many of the views provided may resemble views that may be presented to a user of a client device (e.g., a home personal computer) accessing social networking application 130 via a web browser interface. In this regard, and as may be described herein, the terms “button,” “pull-down menu,” “drop-down menu,” “tab,”“click-box,” “check-box,” “hypertext link,” and “hot link,” are each particular examples of a generic “selection portion” which may comprise any known navigational tool that enables users to select, access, display, or navigate through the features and functionality of application 130.

The selection portions may be accessed using any known input device associated with a client device such as, for example, a keyboard, computer mouse, light stylus instrument, or finger or other body part in a touch-screen implementation. While a selection portion may be described and illustrated as a button in one implementation, it could comprise a different selection portion (e.g., a check-box) in an alternative implementation. These selection portions may be present in addition to the various navigational tools that may be unique to, or associated with, a web browser (e.g., Firefox™) or other interface used to access application 130.

Location-based content may be consumed via a multitude of interfaces. As such, it should be understood that the content, the format of the content, and/or the tools for creating and/or navigating the content may differ depending on the interface used. In other words, while many of the accompanying drawing figures may resemble views displayed to a user of a home PC via a web browser, some or all the same content and options presented in these views may be presented to users accessing application 130, for example, via a mobile computing device, albeit in a device-appropriate format. Different navigational tools (e.g., keys on a keypad) may be used as well depending on a user's device.

User Registration & Settings

In one implementation of the invention, a user may register (or create an account) with application 130 via a registration module. A user may register by accessing application 130 via a web interface (e.g., via a PC), or via any number of other interfaces on any type of device. In one implementation, for example, a user may receive, on his or her mobile computing device, a communication (e.g., e-mail, text message, etc.) from an existing user which includes a link to application 130 to enable registration while mobile. Registration may be free, or users may be charged for access to some or all of the features of application 130. In those implementations when users may be charged, a financial transaction module (or e-commerce engine) may be provided to process payments.

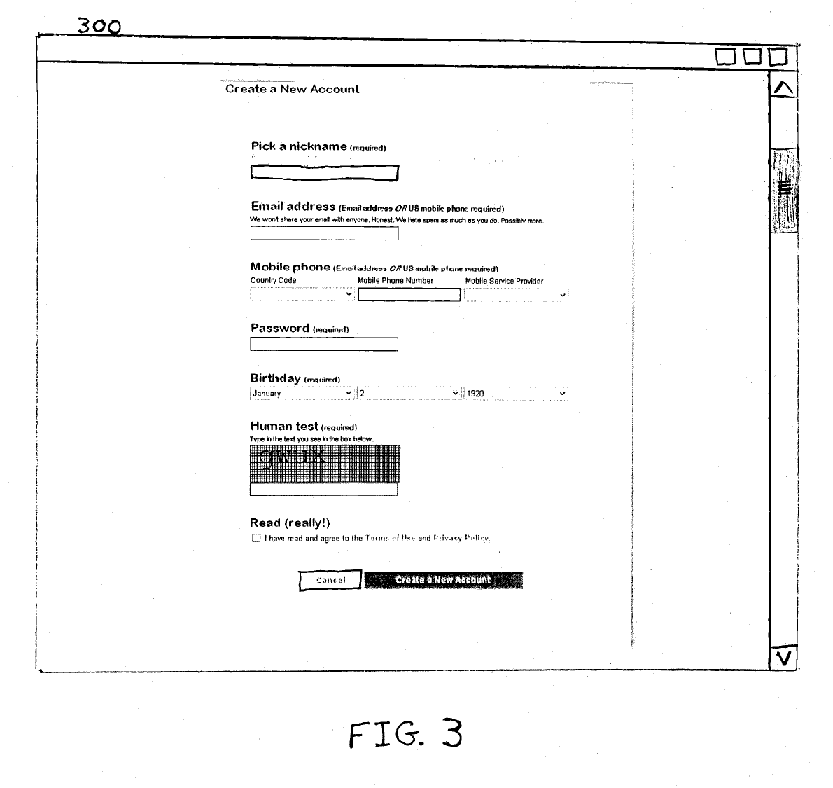

FIG. 3 is an exemplary illustration of a view 300 (including various exemplary data fields) that may be presented to a user during a registration process, according to an aspect of the invention. A user may, for example, be directed to view 300 from a “home page” (not illustrated) presented to the user when application 130 is first accessed. Registration may entail providing user identification information such as a username and/or password. The username may be a nickname (or “screen-name”) or some other identifier that may be used to identify the user to other users of the social network. Users may also select an image (e.g., a picture, piece of artwork, etc.) or other form of media to be displayed along with their username to be viewed by other users. In some implementations, a unique user identifier may be assigned to each registered user, to enable each registered user to be identified on the platform. A unique user identifier may comprise any number of numbers, letters, and/or characters, etc. Other user identification techniques may be implemented.

In various implementations, personal information including any one or more of a full name, residence address, mailing address, date of birth, sex, education level, occupation, marital status, sexual preference, or other information may also be requested during registration.

In some implementations, users may also be prompted during registration to identify one or more personal interests. The personal interests may be used for content filtering purposes. Additionally, users may choose to display one or more of their personal interests (along with other profile data) to other users to enable other users to learn more about them.

Users may also provide contact information during registration. Contact information may include any one or more of an e-mail address, internet service provider, mobile phone number, mobile service provider, or other contact information. In some implementations, contact information and/or other information may be used to generate a unique device identifier. The unique device identifier for a user's device, which may be associated (e.g., in a data record) with his or her unique user identifier, may comprise a user's mobile phone number or any other device-related data.

In some implementations, during registration or at anytime thereafter, some users may download a mobile application (e.g., a Java application) to their mobile computing device that registers their handset with application 130, provides location information, and allows them to access the features and functionality of application 130. Other users may choose not to download the mobile application, instead opting to use SMS and/or MMS transmissions as the means for communication between their mobile computing units and application 130. Still other users may have mobile computing units with web browsers enabling access to a mobile web site (associated with application 130) using Wireless Access Protocol (WAP). Additional communication methods may be utilized.

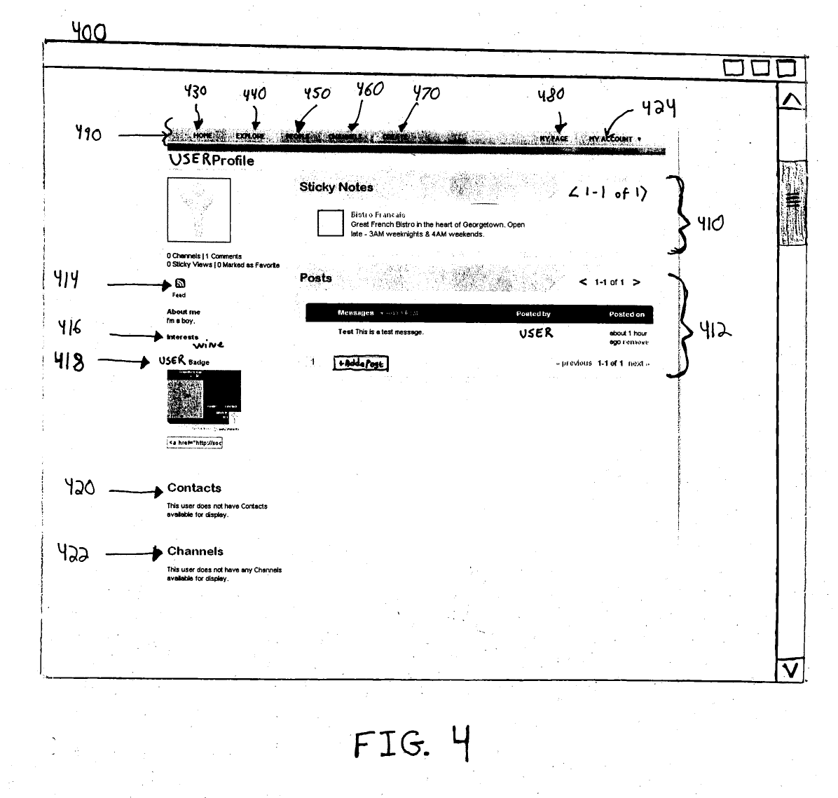

In one implementation, upon completion of a registration process, user profile data may be stored in, for example, databases (140a, 140b, . . . 140n). The user profile data may be retrieved for a user and presented to the user in the form of a personal profile view. FIG. 4 is an exemplary illustration of a personal profile view 400 that may be presented to a user, according to an aspect of the invention. View 400 may be accessed by a user by selecting a “My Page” tab 480 located on a navigation bar 490. A “Home” tab 430, “Explore” tab 440, “People” tab 450, “Channels” tab 460, “Create” tab 470, and “My Account” tab 424 may also be provided on navigation bar 490. Other tabs or selection portions may be presented.

A user profile module may enable users to manage content and modify profile information and various settings (described below) via profile view 400. A display portion 410 may be used to display a list of notification messages associated with location-based messages (or virtual “sticky notes”) created by the user. A notification message may include information about the location-based message (e.g., the message's creator, the title and/or subject matter of the message, etc.), as well as a pointer to the location-based message. As shown, one notification message relating to a restaurant is listed in display portion 410, and its title “Bistro Francais” is provided along with a brief description. A display portion 412 may also be provided in view 400 that lists posts for the user.

A “Feed” selection portion 414 may be provided in view 400 which, when selected, enables a user to retrieve content in a standard format such as RSS or GeoRSS for consumption via a feed aggregator or other external software or service.

An “interests” display portion 416 may list one or more interests (e.g., “wine”) specified by the user. A “User Badge” URL and preview 418 may be provided to allow a user to publish system content in an external website such as a blog.

Additionally, a “Contacts” display portion 420 and “Channels” display portion 422 may respectively display a list of the user's contacts as well as a list of channels to which the user belongs (if the user has made them available for display). Contacts and channels will be described in greater detail below.

In one implementation, by selecting “My Account” tab 424, a user may be presented with one or more interfaces (views) that may enable the user to change passwords as well as add, delete, and/or modify personal information, personal interests, contact information, or other data.

One or more interfaces (views) may also be accessed by a user (via “My Account” tab 424- or other selection portion) that may enable the user to specify and/or modify delivery settings. According to an aspect of the invention, a delivery settings module of application 130 may enable users to specify various filter settings relating to the delivery of notification messages (associated with location-based messages) to their mobile computing devices.

For example, a message sender (or originator) filter enabled by the delivery settings module may enable users to specify that, while mobile, they wish to receive notification messages notifying them of the availability of content from everyone, only from their contacts, or from selected ones of their contacts, or from their contacts' contacts, or from specific users that may not be listed as contacts. Other options may exist. Users, for example, may wish to receive notification messages about content relating to certain specified subjects. Users may also establish timing parameters for the delivery of notification messages.

Additionally, users may specify the number of times that they should receive any particular notification message. As an example, a user that walks an identical route to work or school each day may not want to receive the same notification message over and over again. Some users, however, might wish to continue to receive the notification message to determine whether any user comments, ratings, or other feedback has been associated with the location-based content since they last received the notification message.

According to an implementation of the invention, the delivery settings module may also enable a user to activate or a de-activate a user-centric geographical filter. For example, a user living in a densely populated area has the potential to be inundated with a plethora of notification messages as many users may be creating location-based content for a variety of specific geographical locations. Accordingly, a user may define a geographic area within which he or she would like to receive notification messages. The geographic area may be measured using the location of the user's mobile computing device as the focal point. Other focal points (e.g., the user's home or business address) may also be used. The measurement may be based upon a specified radius (e.g., 100 yards in every direction from the location of the user's mobile computing device) or other geographical measure. Users in sparsely-populated areas, by contrast, may define a larger geographic area, if they define an area at all.

Each user may adjust their own message sender filter and user-centric geographical filter as they see fit (if they are utilized at all) to ensure that they receive a desired volume of notification messages.

In some implementations, a user may also specify whether or not to be notified (or alerted) if other users leave posts (or messages) on his or her profile, or if other users add comments, ratings, or additional content to any location-based messages that he or she previously created. A desired delivery method for such notifications (e.g., e-mail, SMS, etc.) may also be specified by a user.

In one implementation, despite a user's (mobile) delivery settings, any communications designated for system users may be stored in a user-specific queue (or user's system “inbox”) for later consumption.

According to an aspect of the invention, either during registration and/or at any time after, a contacts module may enable users to build and maintain a list of contacts. Application 130 may enable users to create a virtual address book for their contacts and to designate whether other users may view (or otherwise have access to) their contacts.

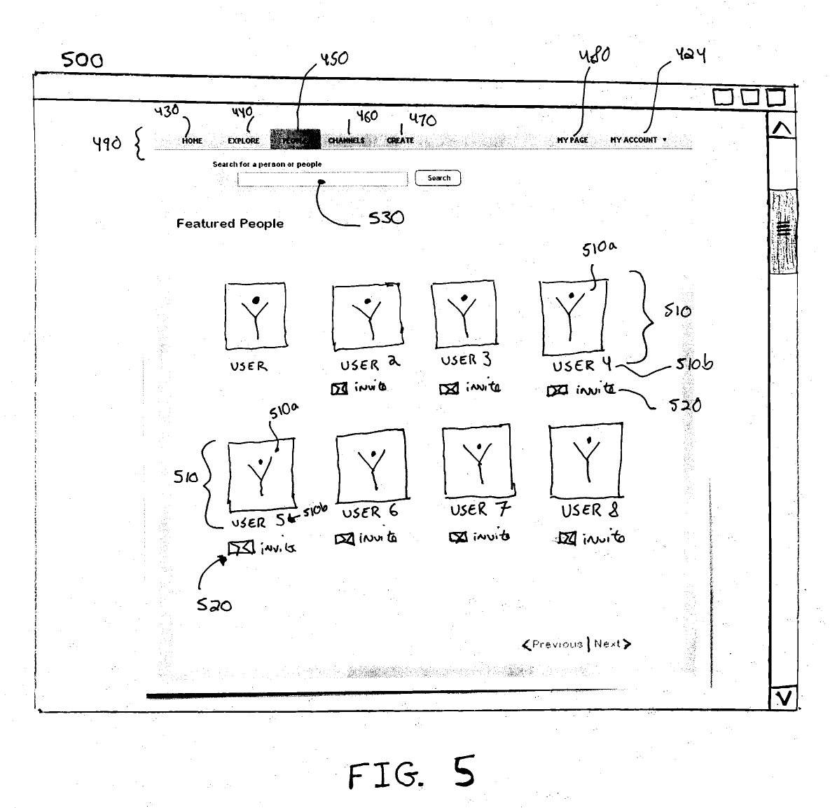

There a variety of ways in which a user may build and maintain a contact network. In one implementation, for example, by selecting “People” tab 450 in view 400 of FIG. 4 (or via any number of other views), a user may be presented with a view 500 as illustrated in FIG. 5. View 500 may display one or more users of application 130. An identification of each displayed user 510 may include either or both of an image 510a (or other form of media) to be displayed along with a username 510b. A user may scroll through the displayed users or enter a username or other user identifier in data field 530 to conduct a specific search.

In one implementation, an “invite” icon 520 or other selection portion may be associated with each displayed user 510 (e.g., user 2, user 3, user 4, . . . user “n”). Selecting an “invite” icon 520 for a user may transmit an invitation request to that user to become a contact (which that user may then accept or decline). In some instances, before an invitation is sent, a user may be prompted to indicate how he or she knows the invitee (e.g., a friend, a family member, from work, from high school, from college, etc.).

In some implementations, either or both of media 510a and username 510b depicted for an identified user 510 (e.g., user 5) may comprise a link (or other pointer) to that identified user's profile. Although not illustrated, profile views for other users on the network may be similar to a user's own personal view 400 as illustrated in FIG. 4. However, profile views for other users on the network may also include an “Add as Contact” link that may be selected to add that particular user (e.g., user 5) to one's list of contacts. In some instances, a targeted user may be automatically added to a contact list, while in others, the targeted user may be provided with the option of accepting or declining another user's attempt to add them as a contact.

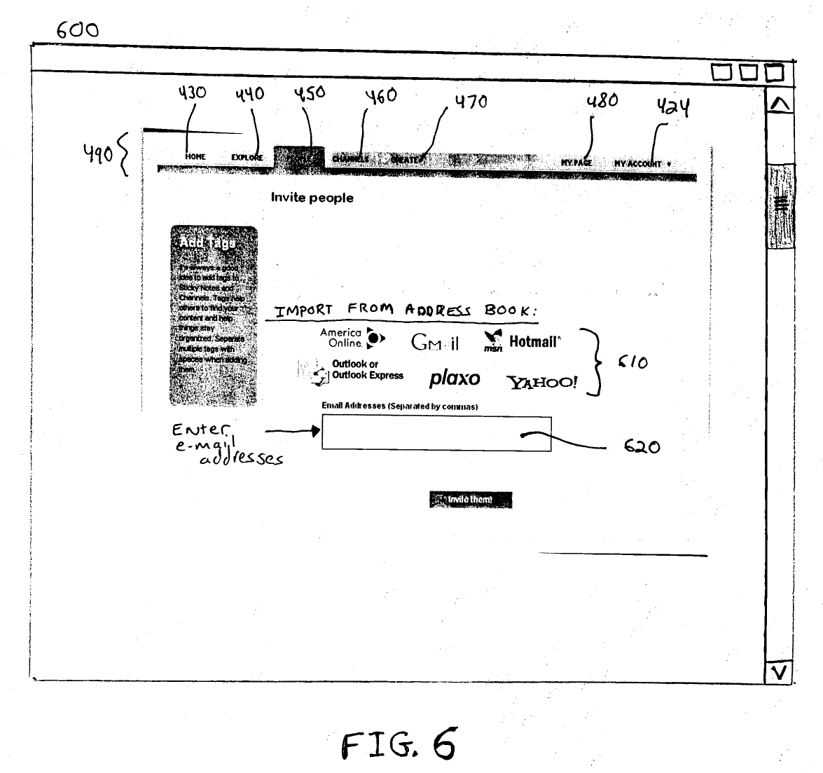

As depicted in view 600 of FIG. 6, users may also build a list of contacts by entering the e-mail addresses of invitees in data field 620, or by importing contacts from “address books” or contact lists from various third-party applications. A display 610 of some third-party applications (e.g., America Online, Gmail, Hotmail, Outlook or Outlook Express, plaxo, Yahoo!) is illustrated in view 600. A user may “click” on (or otherwise select) an icon corresponding to a particular application to commence an “import” process of contact information from that application.

Content Creation

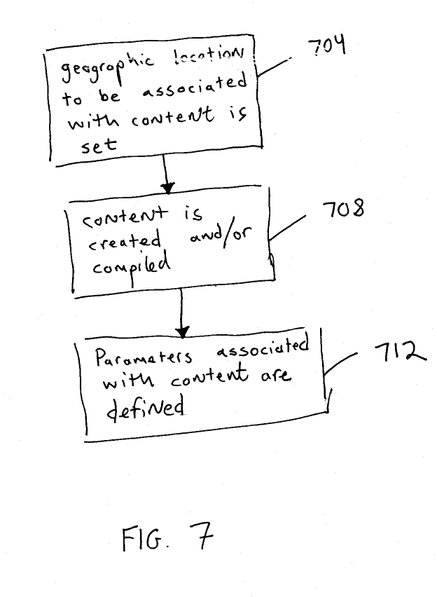

FIG. 7 illustrates a flowchart of processing operations for content creation, according to an aspect of the invention. The described operations may be accomplished using some or all of the system components described in detail above and, in some implementations, various operations may be performed in different sequences (e.g., operation 708 as described herein may occur prior to operation 704). In other implementations, additional operations may be performed along with some or all of the operations shown in FIG. 7. In yet other implementations, one or more operations may be performed simultaneously. Accordingly, the operations described are exemplary in nature and, as such, should not be viewed as limiting.

In an operation 704, a user desiring to create or compile content to be associated with a specific geographic location may provide location data corresponding to the location.

A specific geographic location may comprise a single point, an area (or region) of any size or shape, and, in some instances, moving entities or objects. The location data may comprise location identifier data including, but not limited to, any one or more of coordinates (latitude and longitude), a street address, an intersection, a zip code, or other location identifier data.

The following are some representative, but non-limiting, examples of locations for which location-based content may be set: a circular region having any predetermined radius (e.g., five meters, twenty meters, fifty meters, one hundred meters, one thousand meters, two miles, five miles, twenty miles, etc.); a square geographical region; a region defined by certain property lines; a region around a landmark such as a statue; a street address; a structure at a street address (e.g., home, building, restaurant, bar, club, stadium, theater, mall, music venue, etc.); a region along all of (or along a stretch of) road, highway, etc.; a body of water; a mountain, hill, etc.; an island; a city block, neighborhood, small town, city, etc.; a moving entity (e.g., a vehicle, cruise ship, circus, festival, etc.); or any other type of location. In some implementations, location-based content may be set for locations in a virtual environment (e.g., Second Life® of Linden Research, Inc.; a 3-D virtual world entirely built and owned by its residents).

A user may utilize any number of interfaces to provide location identifier data (to application 130). For example, a user may provide location identifier data via a mobile computing device while physically located at a location. The user may enter data via the mobile computing device, or application 130 may determine a user's location automatically via any of the location-tracking technology described above with reference to FIG. 2A. Location identifier data may also be provided via a PC or other client device remote from the location by selecting a location on a map display, or by entering coordinates (latitude and longitude), a street address, an intersection, a zip code, or other location identifier data.

In an operation 708, content to be associated with the geographical location identified in operation 704 may be created and/or compiled. The content may include any one or more of, for example, text, audio, images, video, or any combination thereof. The location identifier data and the created and/or compiled content may then be associated in a location-based message (virtual “sticky note”).

A content creation module may enable users to utilize any number of interfaces to create and/or compile multimedia content. In some implementations, application 130 may enable content to be received via an API, RSS, and GeoRSS feeds in manner understood by those having skill in the art. Application 130 may also include an API to enable users to create complimentary applications to create and use content.

In some implementations, users may be queried as to whether or not their content is of an “adult” nature, so as to ensure that it is not accessed by minors. Users may be provided with functionality that enables them to alert site administrators of questionable or offensive content, or content that perhaps should be (but has not been) marked as “adult.” Content that violates copyrights may also be flagged (by other users or a system administrator) and removed. In some implementations, as described in greater detail below, users may have the option of organizing content into various topic-centric channels.

In an operation 712, one or more parameters to be associated with location-based content may be defined. Examples or parameters that may be defined may include, but are not limited to, designated recipients, geographic reach, and timing and availability.

In one implementation, a user may designate recipients or groups of recipients that will be authorized to have access to a location-based message that he or she has created. The recipients for any communication can be selected in a variety of ways such as, for example, individually, using a pre-set group of recipients, or using a social software database that manages lists of people with whom the user creating the location-based message has some relation. For example, recipients may be selected according to common interest, business connections, etc.

The following are some representative, but non-limiting, examples of possible ways of designating recipients for location-based messages: all people connected to the user in a social network by one degree; all people connected to the user in a social network by two degrees; all people connected to the user in a social network by three degrees; all people connected to the user in a social network by any number of degrees; all members of a social network; all people in a personal address book; all citizens of a town or city; all members of an organization or club; all people who have dined at a restaurant; all employees of a business; all visitors to a theme park; all members of a high school class; all occupants of an automobile; all contacts in a contact-management database; all people with a common interest in model airplane making; all members of a profession such as doctors; all people with a similar ability such as the ability to juggle; all people who own a product (e.g., such as an Apple MacBook computer); all people who have traveled to a particular place (e.g., Tahiti); all people with a similar artistic taste (e.g., Modernism); all people with a similar taste in food (e.g., those who enjoy sushi); all people born in the same place (e.g., Brooklyn, N.Y.); all people with a common ancestry (e.g., those with ancestors from Italy). Countless other examples exist.

In one implementation, a user may define parameters relating to the geographic reach of a location-based message. For example, the user may specify the size of a geographic area (typically measured in relation to the specific geographic location associated with the content) within which the location-based message will be made available. The region may be of any size and/or dimension including, for example, a circular region having any predetermined radius; a square geographical region; or other region.

In one implementation, users may define timing and availability parameters relating to when, and for how long, a location-based message may be made available to authorized recipients.

A user may define availability parameters to specify the duration (or life-cycle) of a location-based message. For example, a user may specify that location-based messages should be made available for seconds, minutes, hours, days, weeks, months, years, or forever, depending (in many instances) on the nature of the content included in the message. A user may set availability, for example, based on how long a movie (that he or she enjoyed and would like to recommend to others) will be playing at a certain theatre.

Timing parameters may also be used to specify when a location-based message should be made available during its life-cycle. Examples include, but are not limited to, certain hours of the day, certain days of the week, during business hours, while it is raining in a current location, during daylight, during nighttime, during rush-hour, beginning at a predetermined time in the future, etc.

Timing and/or availability parameters may be adjusted as users see fit. For example, a proprietor of a restaurant may create a location-based message that specifies discounted meal prices or other incentives for the restaurant, and may elect to make the message available (in an on-demand fashion) if business is slow in the hopes that nearby message recipients may be lured in. Timing and/or availability parameters enable location-based messages that become less interesting, relevant, or appropriate with age to expire and no longer be received.

In an operation (not illustrated), the content creation module and/or other module(s) of application 130 may compile location data and content, and create a location-based message. The location-based message may be activated and stored in any number of databases (140a, 140b, . . . 140n) (FIG. 2A) along with keywords or other metadata that may be compiled about the location-based message including, for example, its one or more associated content parameters. In some implementations, each location-based message may also be assigned a unique message identifier which may, in some implementations, comprise any number of numbers, letters, and/or characters, etc. A portion of the unique message identifier may, in some cases, include a portion (or all) of the unique user identifier and/or unique device identifier associated with the user that created the location-based message for correlation purposes. Other methods may be utilized for matching users with the location-based messages they create. Location-based messages may be stored and/or sorted according to creator. Location-based messages may also be stored and/or sorted according to location. Other implementations exist.

Each of the operations described with regard to FIG. 7 may enable users to annotate the space around them, and to create content that may be accessed at a time and/or place when it is most relevant. Location-based messages (or virtual “sticky notes”) have numerous beneficial applications, some of which include: enabling users to leave virtual “bookmarks” (e.g., leave “pick-up milk” sticky notes at or near a grocery store); enabling users to tell stories with location-based narrative (e.g., “under this tree I had my first kiss”); enabling play of geo-based games (e.g., scavenger hunts); and enabling users to create their own tours (e.g., a walking tour of a neighborhood or city). Additional uses of location-based messages may include: education (e.g., teachers can set virtual sticky notes for homework assignments); art curation (e.g., a street may be used as a gallery); shopping (e.g., users may notify others of sales, recommendations, etc.); and food (e.g., users can leave personal restaurant reviews for friends). Countless other uses may be enjoyed.

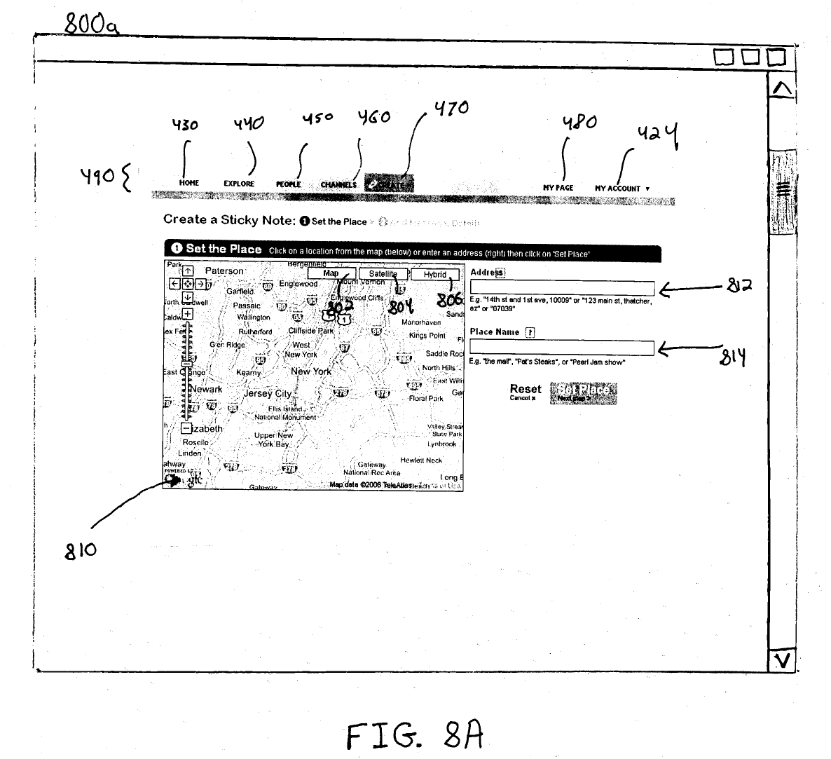

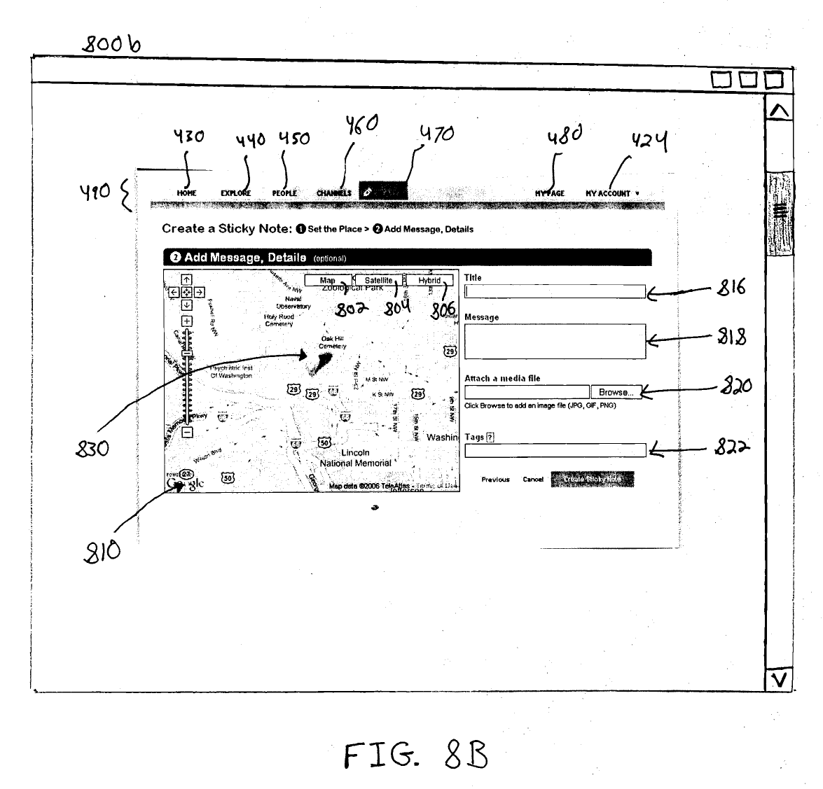

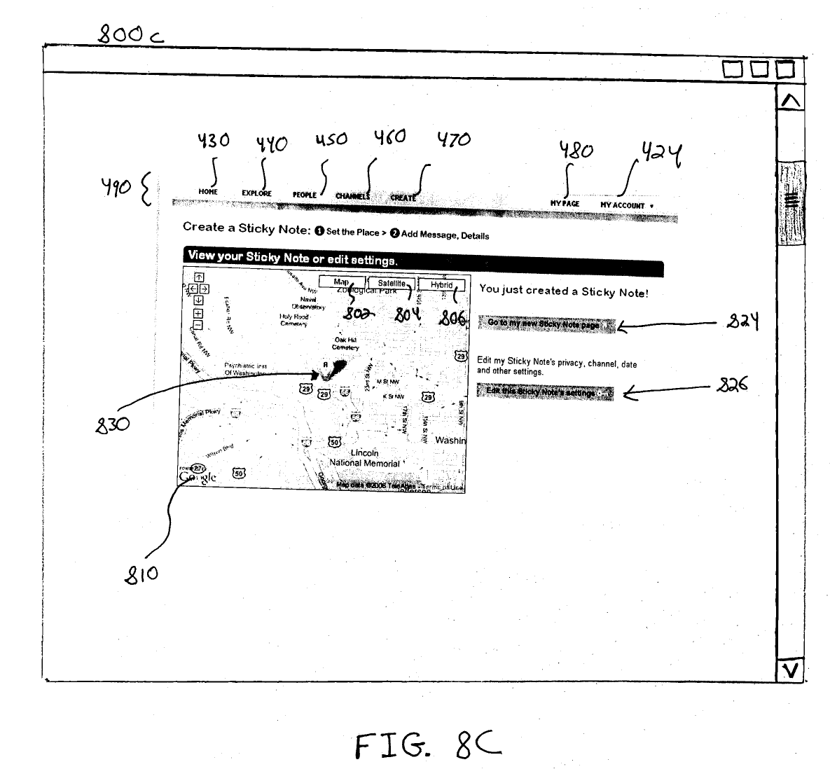

FIGS. 8A-8C are exemplary illustrations of views 800a-880c, respectively, that may be presented to a user while creating a location-based message. In one implementation, a user wishing to create a location-based message (or virtual “sticky note”) may, for example, access view 800a by selecting “create” tab 470 from any number of other views.

View 800a may enable a user to identify a specific geographic location for which the user may wish to create or compile content. Users may identify a location in any number of ways. For example, a user may “click” on (or otherwise select) a location on a map displayed in a map display area 810. Application 130 may receive map data via an API, RSS feed, GeoRSS feed, or by other methods as would be appreciated by those having skill in the art. Users may navigate a map displayed in map display area 810 using various “zooming” and/or directional selection portions. In some instances, a user may also “click and drag” (or otherwise select) a portion of the map displayed in map display area 810 to move the map in various directions. Users may also view location information displayed in map display area 810 via a map view (as shown in FIG. 8A), satellite view, or hybrid view (e.g., aspects of a map view superimposed on a satellite view) by selecting a “map” button 802, a “satellite” button 804, and “hybrid” button 806, respectively.

Users may also identify a location by entering location identifier data in an “address” data field 812. Examples of location identifier data may include, but is not limited to, coordinates (latitude and longitude), a street address, an intersection, a zip code, or other location identifier data. A user may also enter a name to be associated with the location using, for example, “place name” data field 814.

Once a specific geographic location has been identified, a user may be presented with view 800b as shown in FIG. 8B. View 800b may enable users to created and/or compile content to be associated with the geographical location identified in view 800a.

In view 800b, the specified geographic location may be identified via a visual indicator 830 displayed in map display area 810. Visual indicator 830 may be displayed in any number of shapes, colors, sizes, or formats (e.g., as text, as an image or animation, etc.). Users, in view 800b, may assign a title to the location-based message and enter a textual message via “title” data field 816 and “message” data field 818, respectively. An “attach media” selection portion 820 may enable a user to specify, browse for, or import various types of media including, but not limited to, audio files, image files, video files, or any combination thereof. A user may also enter one or more “tags” for the location-based message via a “tags” data field 822. Tags may comprise keywords that might be helpful in enabling users to identify the content at a later time during a search.

In one implementation, after specifying a geographic location and creating and/or compiling the content, a user may be presented with view 800c as illustrated in FIG. 8C. In view 800c, a user may be presented with an option to access the newly created location-based message via a “view” button 824. A user may also designate additional parameters (or settings) to be associated with the location-based message. As described in detail above, examples of these parameters may include, but are not limited to, designated recipients, geographic reach, and timing and availability.

It should be understood that views 800a-880c should not be viewed as limiting. In some implementations, more or less input maybe requested from users and/or view 800b (content creation) may first be presented to a user followed by view 800a (location identification). Alternatively, location identifier data, content, and parameters (or settings) may be specified, compiled, and/or created all in one view. Other implementations may exist.

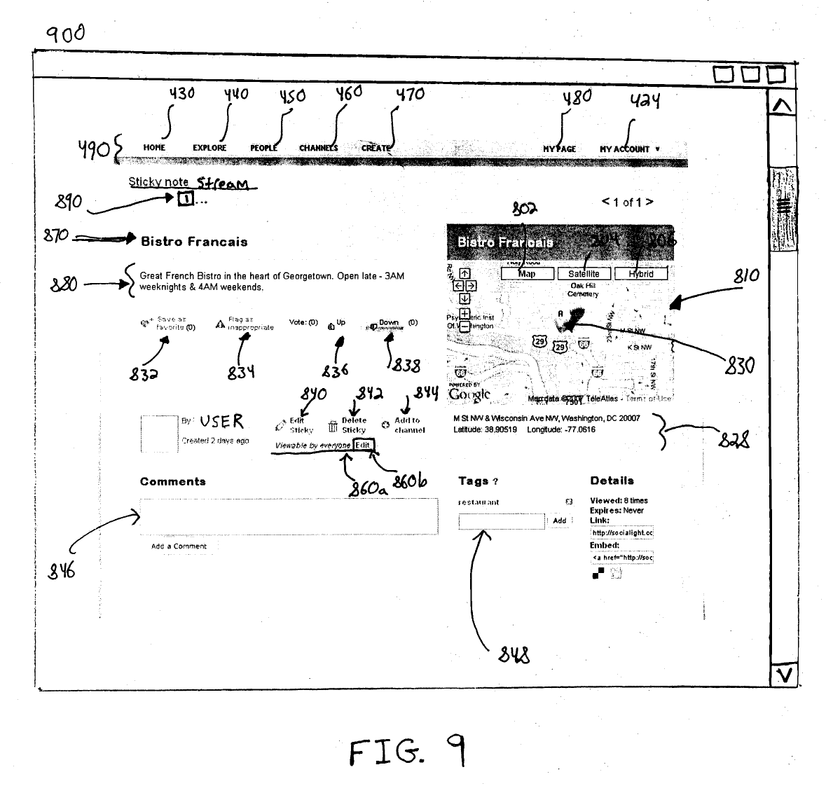

FIG. 9 is an exemplary illustration of a view 900 depicting how a location-based message may be presented to a user, according to an aspect of the invention. As shown, a name or title display portion 870 may be displayed along with a description display portion 880. In addition to map display area 810 and visual indicator 830, a location display portion 828 may also be provided that may display a street address, coordinates, or other location identifier data. A “viewable by:” display portion 860a may indicate which users have been authorized to view the location-based message (e.g., “everyone”).

A location-based message display portion 890 may display an ordered list (or “stream”) of visual indicators corresponding to all (or a selection of) the location-based messages that have been created by the user whose location-based message is currently displayed in view 900. The visual indicators may, for example, comprise links that, when selected, will display the corresponding location-based messages. The stream of visual indicators may be ordered according to creation date (or other filtering criteria) in, for example, ascending or descending order. Users may scroll through the stream of visual indicators and access various ones or more of the corresponding location-based messages to follow the travels of a particular user. As shown in FIG. 9, location-based message display portion 890 only depicts one visual indicator (e.g., the number “1” in a box), since this particular user has only created one location-based message. A user's stream of location-based messages may be displayed in any number of different configurations.

Various options may be presented to users accessing the location-based message for providing feedback. For example, a “save as favorite” selection portion 832 may enable a user to add the location-based message to a list of “favorites.” A “flag as inappropriate” selection portion 834 may be used to alert an application administrator and/or the creator of the message that the message may include questionable or offensive content, or content that perhaps should be (but has not been) marked as “adult” in nature. A “positive rating” selection portion 836 (e.g., “thumbs-up”) and “negative rating” selection portion 838 (e.g., “thumbs-down”) may enable users to provide feedback as well. Users may further provide comments in a “comments” data field 846 as well as add one or more of their own tags in “tags” data field 848. In some implementations, only the creator of the location-based message may have the capability to add one or more tags. Other feedback options may be enabled for users.

In some implementations, various options may be accessible only by the creator of a location-based message (and, in some instances, may not be displayed to users other than the creator). For example, as shown in view 900, users may edit and delete location-based messages via an “edit” selection portion 840 and a “delete” selection portion 842, respectively. Users may also add their location based-message to a channel (described below) via an “add to channel” selection portion 844, and edit parameters (or settings) associated with the location-based message via an “edit settings” selection portion 860. Other options may be enabled for message creators.

As noted above, tools (and methods) for creating and/or navigating content may differ depending on the interface used. For example, in one implementation, application 130 may include a text messaging interface that enables some users of mobile computing devices to communicate with application 130 via SMS, MMS, or e-mail.

The text messaging interface enables users to, among other things, create location-based messages by transmitting location identifier data and new location-based content. As an example, in one implementation, a user may transmit location identifier data to a specified address in the following format:

@[your address/Zipcode/City, State].

Example: @36 e 12th st, 10003 (City and/or State may be optional).

To create content, text and/or pictures may then be transmitted in the following format:

[text].

Example: just finished moving into the new office

Location identifier data and content may also be sent together in one transmission using the following format:

@[text]@[your address/Zipcode/City, State].

Example: just finished moving into the new office@36 e 12th st, 10003

The text messaging interface may further enable users to search for location-based messages near a particular location by transmitting search queries. Users may transmit queries in the following format:

?[search query or leave blank for everything]@[your address/Zipcode/City, State].

Example: ?sushi@10003

Example: ?shopping (if location identifier has already been recently provided).

A search module and/or other module(s) of application 130 may, depending on a user's specified delivery settings, provide search results identified from contacts, channels, or everyone. In some implementations, application 130 may continue to transmit relevant search results (e.g., if new location-based messages have been created nearby) for a predetermined period of time (e.g., 2 hours), or until a user transmits a “stop” or other similar message to application 130. In some implementations, at the conclusion of the predetermined time period, application 130 may prompt the user to determine whether the user wishes to continue to receive communications. A user may respond in the affirmative by transmitting a “stay” or other similar message to application 130. Otherwise, a user may just ignore the message. Other methods may be implemented.

Content Creation—Channels

According to an aspect of the invention, a channel module of networking application 130 may enable system users, third-party publishers, or other individuals or entities to create and moderate a topic-centric body of location-based content which may be referred to herein as a “channel.” Users that subscribe to channels may receive notification messages on their mobile computing devices when they are within a predetermined distance of a specific geographic location for which topical location-based content has been created. Users may access the location-based messages associated with the notification messages immediately, or at a later time (if at all). Subscribers to a real-estate channel for example, may view rich media listings using a mobile computing device while out walking or driving in an area.

Various types of channels may exist. For example, some channels may be “public” channels that may be accessible by any user interested in the particular topic of the location-based content of the channel.

Other channels may be restricted to only those users invited (or accepted) by the creator of the channel. For example, some users may wish to create their own channel based on personal preferences and insights and share it only with friends. The existence of these channels may be made public in that users may know they exist, although they must still be invited (or accepted) to access the location-based content. Alternatively, the existence of these channels may be kept private and non-invited users may never know of their existence.

An additional type of channel may comprise a channel having location-based content that a user must pay to access. Similar to the channels described above, creators of these “pay” channels may make the existence of these channels known to users (regardless of whether anyone can join or if they are “invitation-only”), or keep them private and accessible on an invitation-only basis. In some implementations, creators of “pay” channels may charge a one-time or periodic subscription fee that is determined by them. The administrator or service provider that maintains social networking application 130 may, as a result of providing the platform (or marketplace), handle any financial transactions and/or manage subscription data, and provide the channel creator with a percentage of any fees collected. Financial transactions may be processed via a financial transaction module (or e-commerce engine). Other business arrangements by and between channel creators and the application administrator or service provider may be contemplated.

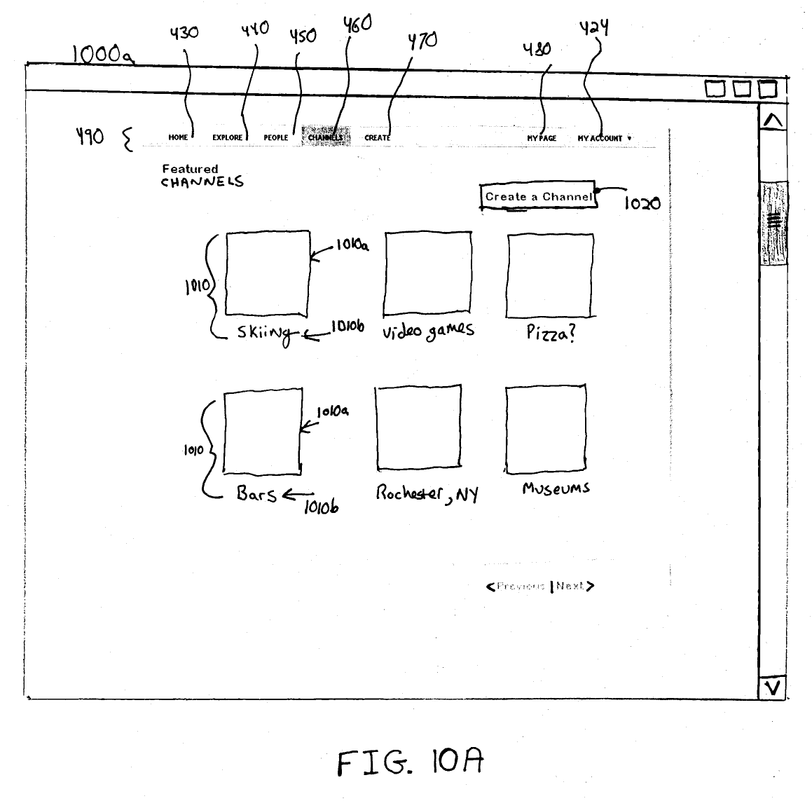

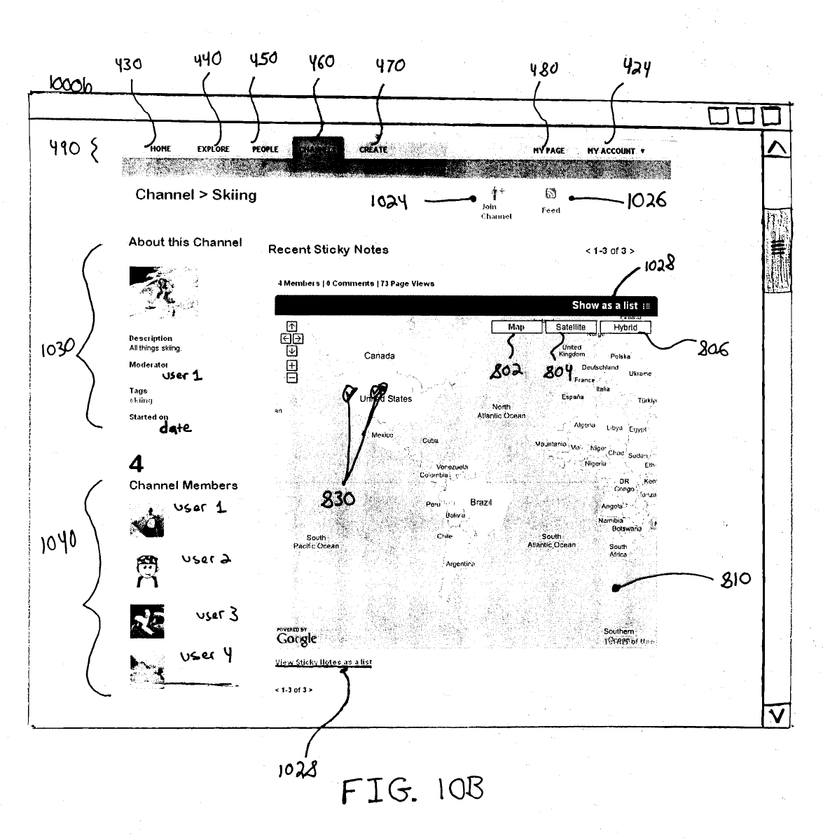

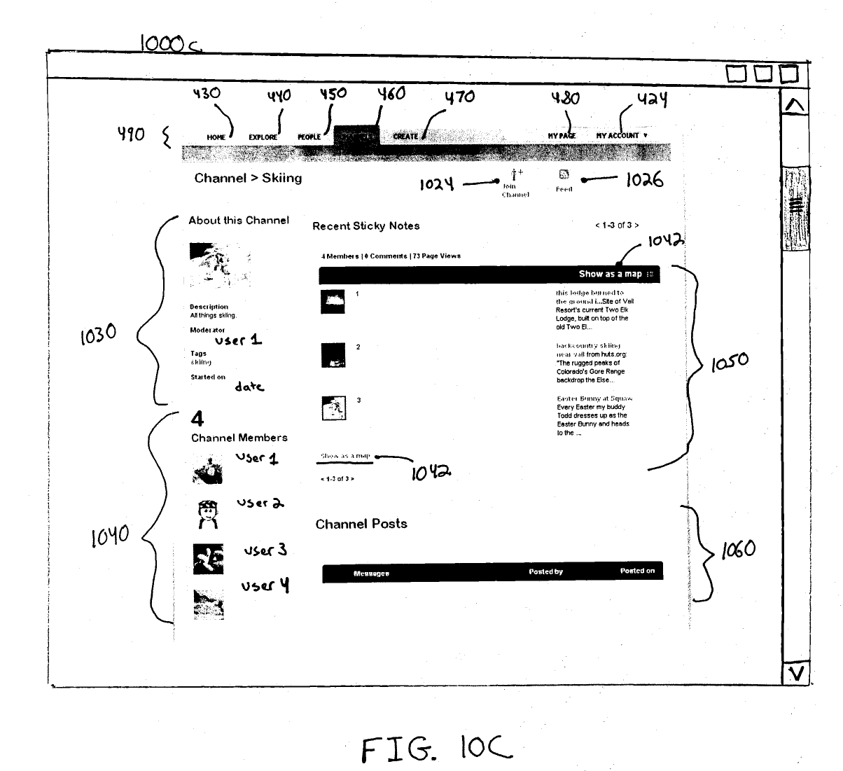

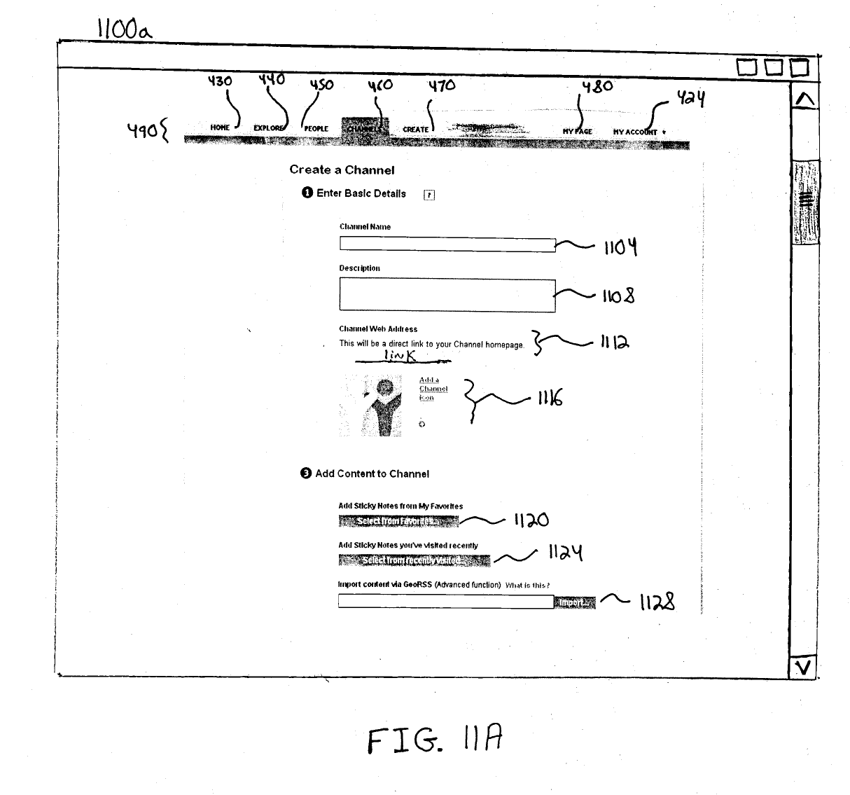

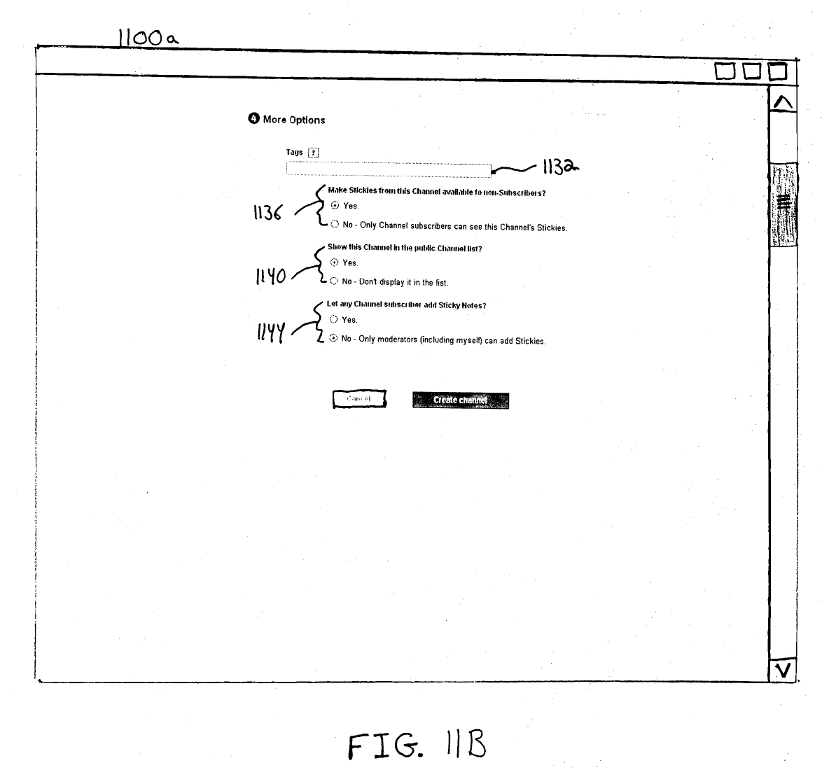

According to an aspect of the invention, in addition to determining what type of channel may be used, a channel creator may further define various channel settings. Channel settings may be used to define, among other things, who may access location-based messages (or virtual “sticky notes”) associated with the channel, who may add location-based messages to a channel, and/or who may post comments, feedback, ratings, etc. on location-based messages. Additional features and functionalities associated with various aspects of channels will now be described with reference to FIGS. 10A-10C and 11A-11B.

In one implementation, by selecting “channels” tab 460, a user may be presented with a view 1000a as illustrated in FIG. 10A. View 1000a may display one or more channels. An identification of each displayed channel 1010 may include either or both of an image 1010a (or other form of media) to be displayed along with a channel name 101b (or other channel identifier). A user may scroll through the various displayed channels looking for potential channels whose topics may be of interest. Though not illustrated in view 1000a, a search field may also be provided to enable a user to enter one or more search terms to try and locate channels whose topics may be of interest. In some implementations, either or both of media 1010a and channel name 100b depicted for an identified channel 1010 may comprise a link (or other pointer) to a view associated with that channel.

As an example, a selection made by a user interested in skiing may result in a view 1000b being presented to the user, as illustrated in FIG. 10B. View 1000b may include an “about channel” display portion 1030 which may display any type of data about the “skiing” channel including, but not limited to, media (e.g., text, images, audio, video, etc.), a description of the subject matter or topic of the channel (e.g. “all things skiing”), the name or other identifier of the channel moderator, any tags (e.g., “skiing”) for keyword searching, and the date the channel was created.

In some implementations, a “channel member” display portion 1040 may display a list of some or all of the members of the channel. The list may or may not comprise links to each user's system profile (e.g., similar to the profile illustrated in FIG. 4). View 1000b may further comprise a “join channel” selection portion 1024. In some implementations, a user's request to join a channel may have to be approved depending on the type of channel the channel creator has established. A “Feed” selection portion 1026 may also be provided to enable users to retrieve content in a standard format such as RSS or GeoRSS for consumption via a feed aggregator or other external software or service.

According to one implementation, map display area 810 in view 1000b may display one or more visual indicators 830 which may graphically depict specific geographic locations associated with location-based messages (or virtual “sticky notes”) relating to skiing. In some implementations, each visual indicator 830 may include a pointer to its corresponding location-based message, thus enabling a user to access the location-based message.

According to an aspect of the invention, a user may wish to view a listing of information relating to the “skiing” location-based messages, rather than the visual indicators depicted on map display area 810. Accordingly, the user may select a “view/show as list” selection portion 1028 in view 1000b in order to be presented with a view 1000c, as shown in FIG. 10C. View 1000c may include a list display 1050 which depicts information about location-based messages of the skiing channel in a list. In some implementations, a “posts” display 1060 may also be provided. A user may (or may not) be able to post, and may (or may not) be able to view posts of others based on channel settings defined by the channel creator. Users may return to the map-based view 1000b of FIG. 10B by selecting a “show as map” selection portion 1026.

According to an aspect of the invention, a user wanting to create a channel may select “Create Channel” button 1020 in, for example, view 1000a (FIG. 10A) or from any number of other views.

A user may then be presented with view 110a (which is illustrated as spanning FIGS. 11A-11B) which may prompt them to provide a variety of information to create a channel. For example, a user may enter a channel name and provide a description of the channel via a “channel name” data field 1104 and “description” data field 1108, respectively. A “link display” portion 1112 may display a format of a URL (or other address) that may be used to enable users to access a channel directly. In some implementations, an “add media” selection portion 1116 may enable a user to add text, an image, an animation, a video, etc. that may be displayed to channel users (e.g., a *.jpeg of a skier for a skiing channel, etc.).

Content (e.g., location-based messages) may be added to channels in a variety of ways. Existing location-based messages may be added to channels, for example, or location-based messages may be added to a channel during the creation process. A “select from favorites” selection portion 1120 may enable a user to browse and select from a list of location-based messages that he or she has compiled in a “favorites” list. A user may further add location-based messages to a channel from messages recently accessed via a “select from recently visited” selection portion 1124.

In some implementations, a user may import content to be included in his or her channel by selecting an “import content” selection portion 1128. Content may be fed in from an external data source via an API (see FIG. 2B). Users may also add content via an RSS feed and/or GeoRSS feed. For example, content may be fed in from the external data source at the initial time of specification of the source, then at regular intervals as a scheduled process. Content may have been created specifically for the system, or may also be used for another purpose. In some implementations, users may specify multiple data sources for import.

According to an aspect of the invention, in addition to entering information about a channel and adding content to a channel, users may also be presented with additional options. For example, a channel creator may also enter one or more tags for the channel (for keyword searching purposes) via a “tags” data field 1132.

During channel creation, users may also specify settings for the channel, such as, which users or groups of users may access the channel, whether users will be charged for access, whether the existence of the channel will be public or private, whether users will be required to “pay” for access, and/or whether users may be able to post comments, feedback, ratings, etc. on channel content. Other settings may be specified. View 1100a (FIG. 11B) illustrates some examples of settings that may be specified by a channel creator. As shown, a “content availability” selection portion 1136 may enable a channel creator to specify whether location-based messages associated with the channel will be accessible by non-subscribers. A “display preference” selection portion 1140 may enable the user to specify whether the existence of the channel will be public or private. A “third-party submission” selection portion 1144 may also be provided to enable creators to specify whether users may be able to post comments, feedback, ratings, etc. on channel content.

Location & Notification

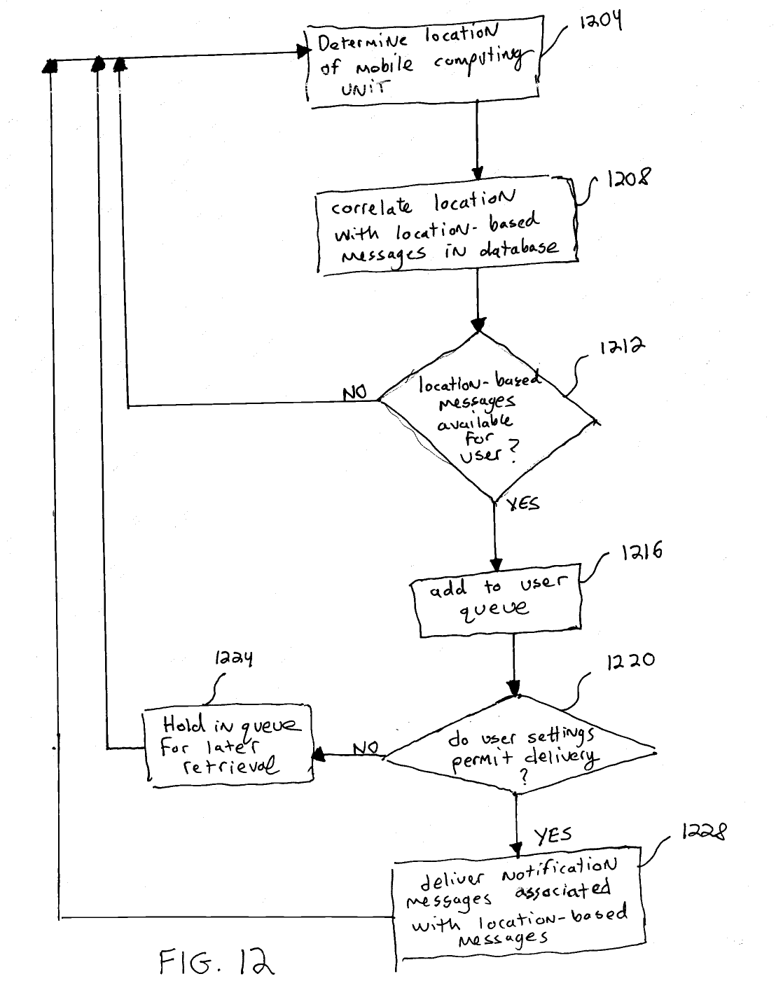

FIG. 12 illustrates a flowchart of processing for locating and notifying users of the availability of location-based content, according to an aspect of the invention. The described operations may be accomplished using some or all of the system components described in detail above and, in some implementations, various operations may be performed in different sequences. In other implementations, additional operations may be performed along with some or all of the operations shown in FIG. 12. In yet other implementations, one or more operations may be performed simultaneously. Accordingly, the operations described are exemplary in nature and, as such, should not be viewed as limiting.

In an operation 1204, the location of a user's mobile computing device may be determined via any of the location-tracking technology previously described herein. A location determination module may utilize any one of a number of timing algorithms in operation 1204. For example, in one implementation, the application may query for and report location at any predetermined time interval (e.g., once every 5 minutes). If it is determined that the location of a user's mobile computing device has changed by more than any predetermined distance (e.g., 100 yards (after any predetermined time interval, then the predetermined time interval may be decreased (e.g., from once every 5 minutes to once every minute). Otherwise, the predetermined time interval may remain constant. If after a predetermined number of subsequent queries, the location has changed by less than the predetermined distance, the predetermined time interval may be returned to its initial value.

As an example, a user may be sitting in a restaurant. Their location may be determined every 5 minutes. The person may get up to go to the bathroom (e.g., with their mobile computing device clipped to their belt), but doesn't move more than 100 yards so the predetermined time interval may remain at 5 minutes. After dining, while driving home, for example, a query may indicate that the predetermined distance has changed (the user has moved more than 100 yards from the last reported location). Accordingly, the predetermined time interval may be decreased from once every 5 minutes to once every 60 seconds. If, after a predetermined number of subsequent queries, it is determined that the location has changed by less than the predetermined distance (e.g., the user has arrived home), the predetermined time interval may be returned to its initial value. Depending on future movement, the predetermined time interval may increase to an even greater interval (e.g., such as every 30 minutes or 60 minutes) if no movement is detected after a predetermined number of queries. Other algorithms may be used.

In an operation 1208, the location determined in operation 1204 may be correlated with location-based messages stored in one or more of databases (140a, 140b, . . . 140n) to identify any location-based messages for locations in and around (proximal to) the user's current reported location. In an operation 1212, a determination may be made as to which, if any, of the identified location-based messages may be made available to the user. In some instances, operations 1208 and 1212 may be combined and/or accompanied by additional operations. A content targeting module may utilize any number of algorithms to determine which location-based messages may be available to any given user. Such algorithms may rely on one or more of the following filtering criteria: the location determined in operation 204; identity of the user (obtained via a unique device identifier, unique user identifier, etc.); current local time at the reported location; parameters associated with location-based messages as defined by their creators (e.g., designated recipients, geographic reach, timing and availability information, etc.); whether the user has subscribed to any channels; social relevance (as determined, for instance, by any number of different filtering criteria); message status (e.g., active, expired, etc.); historical usage of the system by the user; feedback provided to the location-based message by the user or other users (e.g., comments, ratings, etc.); or other criteria or information.

If it is determined in any or both of operations 1208 and 1212 that no location-based messages are available for the user, then processing may resume with operation 1204 so that the location of the user's mobile computing device continues to be monitored.

By contrast, if it is determined in any or both of operations 1208 and 1212 that location-based messages are available for the user, notification messages associated with the available messages may be placed in a queue for user (e.g., a user's system inbox) in an operation 1216.

In an operation 1220, a determination may be made as to whether a user's settings permit delivery of notification messages corresponding to the location-based messages. For example, although location-based messages may be available for consumption by a user, he or she may have defined delivery settings specifying that no notification messages should be delivered at certain times of the day, certain days of the week, etc., or that they only wish to receive notification messages (while mobile) about content created by certain individuals (e.g., people in their list of contacts). Other types of delivery settings may be specified.

If a determination is made in operation 1220 that delivery of one or more notification messages should not occur, then available content may be held in the user's queue (e.g., a user's system inbox) for later consumption, and processing may resume with operation 1204 so that the location of the user's mobile computing device continues to be monitored.

If, however, it is determined in operation 1220 that notification messages may be delivered, then delivery is initiated in an operation 1228. Processing may also then resume with operation 1204 so that the location of the user's mobile computing device continues to be monitored.

According to an aspect of the invention, and as previously described, notification messages transmitted to a user's mobile computing device may include information about the location-based message (e.g., the message's creator, the title and/or subject matter of the message, etc.), as well as a pointer to the location-based message. Based on the information included in the notification message, a user may elect to access the content in the location-based message immediately, at a later time through any number of interfaces, or to disregard the location-based message entirely.

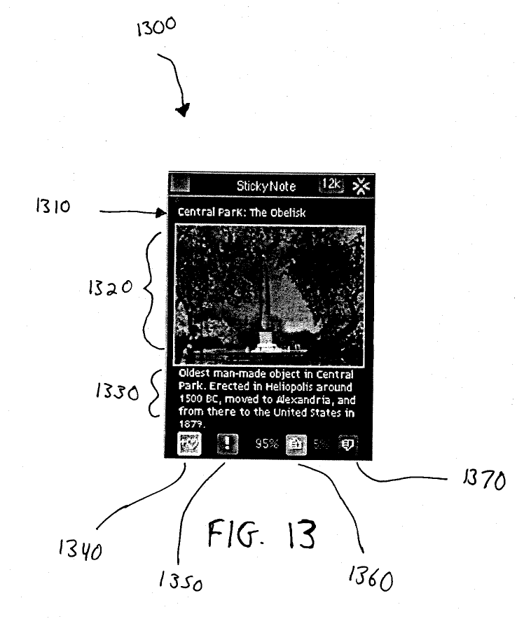

Users electing to access the content in the location-based message using their mobile computing devices may view, navigate, and respond to content differently based on their particular devices. For instance, FIG. 13 is an example of a location-based message 1300 that may be displayed to a user whose mobile computing device is running a mobile application (e.g., a Java application). Message 1300 may include a message name display portion 1310, a media display area 1320, and a description display portion 1330. A “save as favorite” selection portion 1340, “flag as inappropriate” selection portion 1350, “positive rating” selection portion 1360 (e.g., “thumbs-up”), and “negative rating” selection portion 1370 (e.g., “thumbs-down”) may enable users to provide feedback as well. FIG. 13 should not be viewed as limiting.

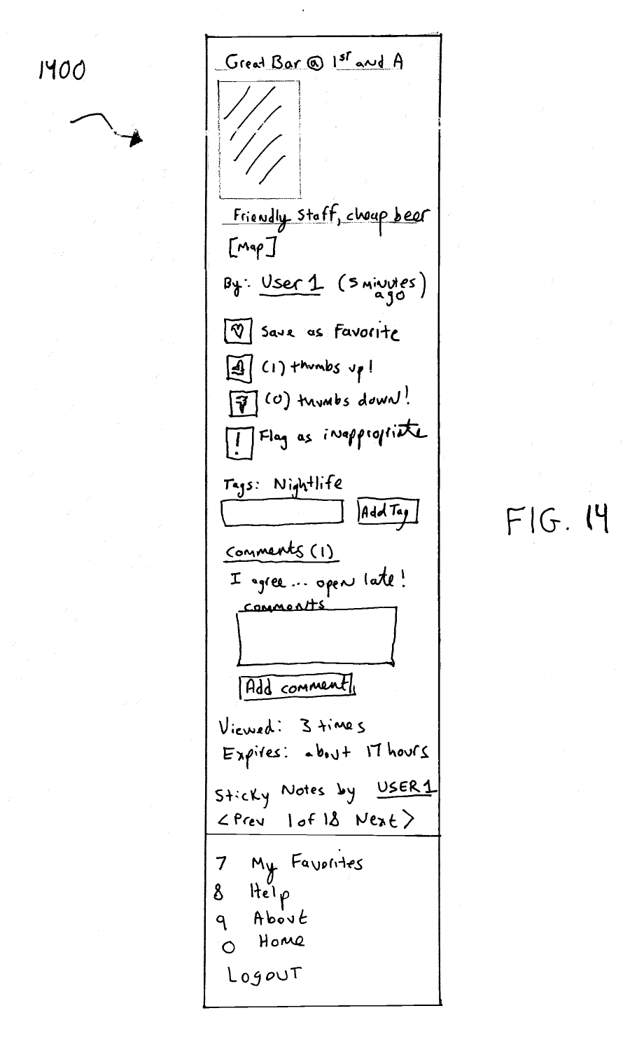

As an additional example, FIG. 14 is an example of a location-based message 1400 that may be displayed to a user whose mobile computing device is accessing a mobile web site (associated with the application) using WAP. As shown, message 1400 includes examples of selection portions and display portions explained throughout this application. FIG. 14 should not be viewed as limiting.

Exploring Content

As has been previously described, the system and method of the invention is advantageous in that enables multimedia location-based messages to be consumed, not just on one's mobile computing device, but via a multitude of interfaces. Examples of suitable interfaces through which location-based messages may be consumed include, but are not limited to, a mobile phone application, a mobile web browser, a mobile computer, a personal computer web browser, a personal computer application, a public video screen display, a television, or a voice telephone automated voice-response system. Enabling messages to be consumed in various formats, through various interfaces, and at various times enables users to browse and search through location-based messages in various ways that allow for more effective consumption of the media. For instance, messages may be viewed immediately after they are created or at a later time, for example five (5) minutes later, in the evening of the same day, the next week, the next year, or ten (10) years later.

The system and method of the invention is also advantageous in that it maintains a usefully structured record of location-based messages. This enables users to view their own, or some other user's, history of location-based messages in order to recall where the user traveled in the past, or to find some location-based content that had been retrieved via a message in the past.

Various interfaces may be provided to enable users to filter and view location-based content according to any number of different criteria. A display module may enable location-based messages to be browsed and viewed, for example, by geographical location, by content creator or content subject, by channel, by content rating, by a user rating, by altitude, or via any number of other filtering criteria.

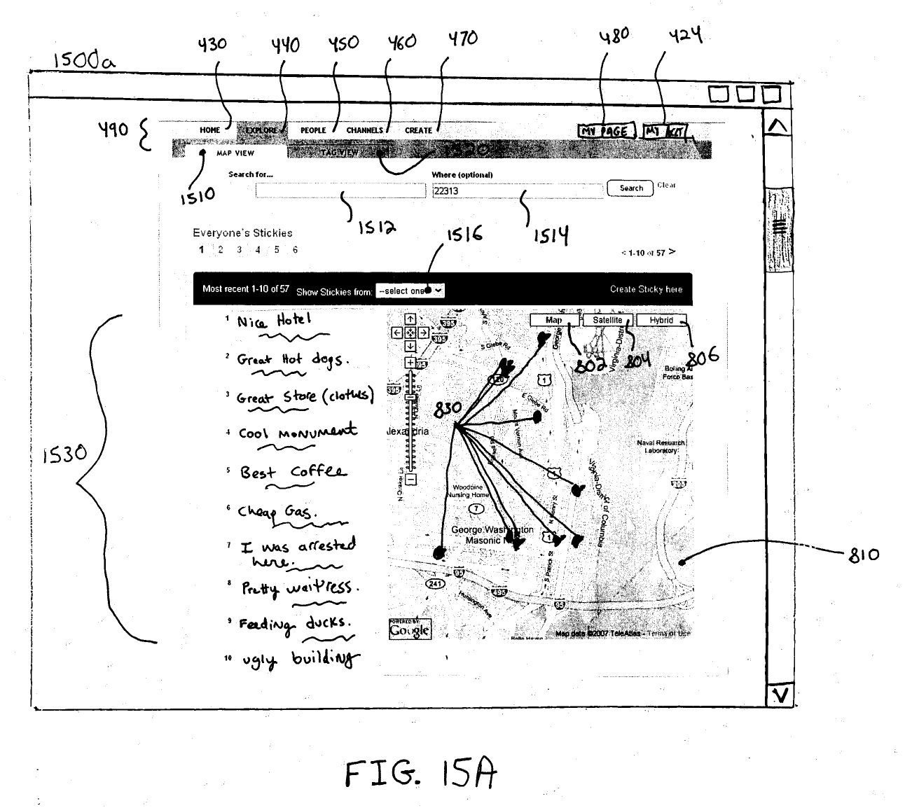

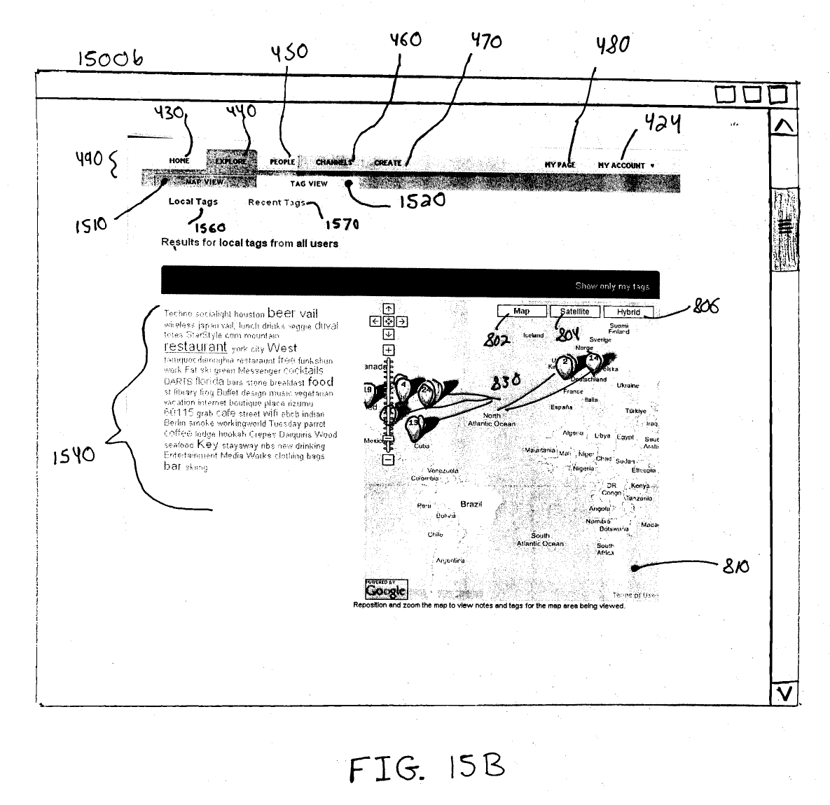

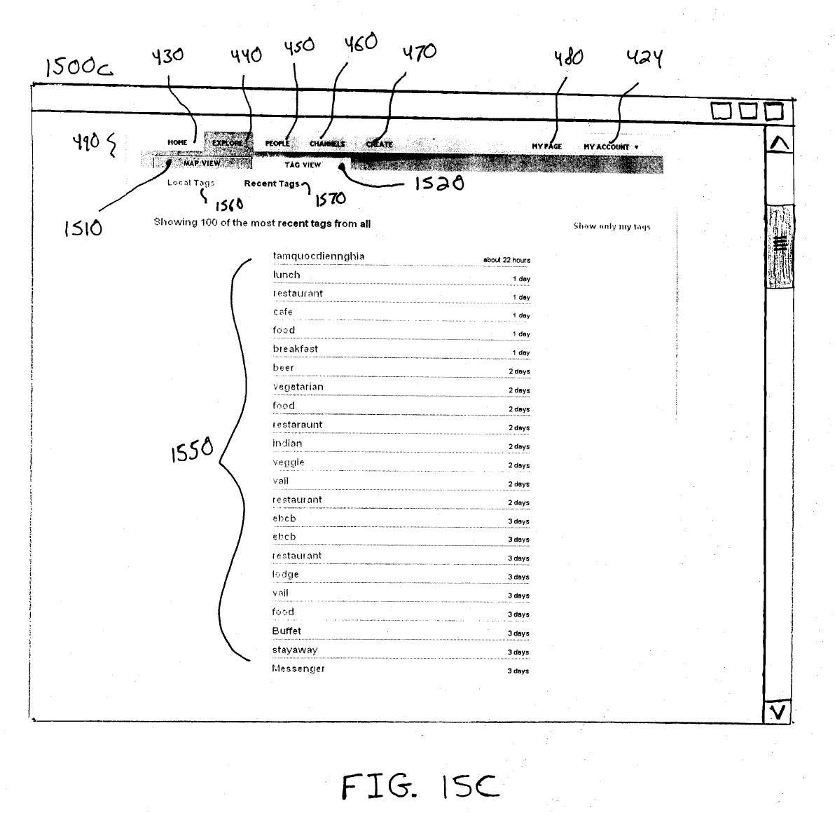

FIGS. 15A-15C are exemplary illustrations of views that may be presented to a user while exploring location-based content, according to an aspect of the invention. In one implementation, view 1500a (FIG. 15A) may be accessed by selecting “explore” tab 440 from any number of different views. View 1500a may include a “list display” 1530 that displays information about various location-based messages. Visual indicators 830 displayed in map display area 810 may graphically depict specific geographic locations associated with the corresponding location-based messages identified in “list display” 1530.

Users may search for various location-based messages by entering one or more search words in “search” data field 1512. Users may also enter any type of location identifier data (e.g., zip code “22313”) in “location identifier data” data field 1514. Additionally, a “creator” drop down menu 1516 or other selection portion may enable users to select to view location-based content created by a specific user, by groups of users, or by all users. Other filtering functionality may be enabled in view 1500a.

In one implementation, view 1500a may also include a “map view” tab 1510 and a “tag view” tab 1520. Selection of “map view” tab 1510 enables a user to view a display like the one depicted in FIG. 15A (view 1500a). Selection of “tag view” tab 1520 enables a user to access a view similar to view 1500b as depicted in FIG. 15B.

In addition to map display area 810 (with the depicted visual indicators 830), view 1500b may also include a “local tags” display portion 1540. “Local tags” display portion 1540 may display a list of tags (keywords) that have been associated with any location-based messages associated with specific geographic locations within map display area 810. As such, the tags displayed in “local tags” display portion 1540 may vary as the area shown in map display area 810 changes.

As an example, a user may focus the map in on New Orleans, La. using the zooming and/or directional selection portions provided in map display area 810. “Local tags” display portion 1540 may then display tags associated with any location-based messages associated with specific geographic locations within New Orleans. This feature enables users to determine quickly, based on the tags displayed, what types of things are relevant in a particular area.

In some implementations, the visual attributes (e.g., font size, font style, color, or other attribute) of tags displayed in “Local tags” display portion 1540 may vary depending on the number of location-based messages that have been created (and assigned that tag) within the geographic area shown within map display area 810. For instance, if numerous users have created location-based messages associated with restaurants in New Orleans, and tagged those messages with the tag (or keyword) “restaurant,” then the size of the word (or tag) “restaurant” as it appears in “Local tags” display portion 1540 may be quite large. As such, a user viewing the tags in “Local tags” display portion 1540 may deduce that restaurants in New Orleans are the subject of numerous location-based messages and, thus, may be a “hot topic” because they are quite good, quite bad, or noteworthy for some other reason.

In one implementation, view 1500b may also include a “local tags” tab 1560 and a “recent tags” tab 1570. Selection of “local tags” tab 1560 enables a user to view a display like the one depicted in FIG. 15B (view 1500b). Selection of “recent tags” tab 1570 enables a user to access a view similar to view 1500c as depicted in FIG. 15C. View 1500c may include a “recent tags” display portion 1550 which may depict a predetermined number (e.g., 100) of tags created within a recent predetermined time period (e.g., within the last hour, day, week, etc.).

The features and functionality illustrated in FIGS. 15A-15C are but a few examples of the ways in which location-based content may be consumed in various formats, through various interfaces, and at various times. Other possibilities exist. As such, these figures should not be viewed as limiting.

According to an aspect of the invention, advertisers may be permitted to insert advertisements, coupons, or other incentives on various interfaces (views) of social networking application 130. This advertising content may be displayed for a fee. Advertisers may publish advertisements to the system directly or indirectly such as through an external advertising network. Advertisers may select various options to determine the features of potential advertising recipients including, but not limited to, recipient location, age, sex, interests, and past behavior on the system. Fees paid by advertisers to the system provider, whether directly, or through an external advertising network, may be shared with publishers of the content that is displayed near the advertising on the system's interface.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method of notifying a user of the availability of accessible content associated with one or more geographic locations located proximal to the user's location, comprising:
determining a location of a mobile computing device associated with a user;
identifying, based on the determined location and one or more filtering criteria, one or more location-based messages available to the user, wherein a location-based message comprises location identifier data and content associated with the location-identifier data; and
transmitting, for each identified location-based message available to the user, a notification message to the user's mobile computing device, wherein a notification message includes information about its corresponding location-based message, as well as a pointer to its corresponding location-based message to enable the user to access the location-based message.

2. The method of claim 1, wherein determining a location of a mobile computing device further comprises:
determining the location of the mobile computing device at a predetermined time interval; and
decreasing the predetermined time interval if the location of the mobile computing device has changed by more than a predetermined distance from a previously-determined location.

3. The method of claim 1, wherein the location identifier data comprises geographic coordinates.

4. The method of claim 1, wherein the location identifier data comprises a street address.

5. The method of claim 1, wherein the location identifier data comprises a zip code.

6. The method of claim 1, wherein the content of a location-based message comprises text.

7. The method of claim 1, wherein the content of a location-based message comprises audio.

8. The method of claim 1, wherein the content of a location-based message comprises one or more images.

9. The method of claim 1, wherein the content of a location-based message comprises video.

10. The method of claim 1, wherein the content of a location-based message comprises any combination of media selected from among text, audio, images, and video.

11. The method of claim 1, wherein the one or more filtering criteria comprises one or more message parameters defined by a creator of a location-based message.

12. The method of claim 11, wherein a message parameter comprises a designation of one or more users authorized to access the location-based message.

13. The method of claim 11, wherein a message parameter comprises a geographic area within which the location-based message will be made available.

14. The method of claim 13, wherein the geographic area is defined in relation to location-identifier data specified for the location-based message.

15. The method of claim 11, wherein a message parameter comprises a specified life-cycle for the location-based message.

16. The method of claim 1, wherein a message parameter comprises a predetermined time during which the location-based message will be made available.

17. The method of claim 1, further comprising:
enabling a user to specify one or more delivery settings governing transmission of notification messages to the user's mobile computing device.

18. The method of claim 17, wherein a delivery setting comprises a specified time during which the user does not wish to receive notification messages.

19. The method of claim 18, further comprising storing undelivered notification messages in a user-specific queue for later retrieval by the user.

20. The method of claim 17, wherein a delivery setting comprises a designation of one or more users from which a user does not wish to receive notification messages via their mobile computing device.

21. The method of claim 20, further comprising storing undelivered notification messages in a user-specific queue for later retrieval by the user.

22. The method of claim 1, wherein the information in a notification message, about its corresponding location-based message, comprises an identifier of the creator of the location-based message.

23. The method of claim 1, wherein the information in a notification message, about its corresponding location-based message, comprises a description of the subject matter of the location-based message.

24. The method of claim 1, further comprising:
storing a notification message, corresponding to each identified location-based message available to the user, in a user-specific queue.

25. The method of claim 1, further comprising:
storing each identified location-based message available to the user in a user-specific queue.

26. The method of claim 1, further comprising:
enabling the user to add comments to a location-based message that the user has accessed, wherein the comments will be stored with the location-based message and made available to subsequent users accessing the location-based message.

27. The method of claim 1, further comprising:
enabling the user to rate the content of a location-based message that the user has accessed.

28. The method of claim 1, further comprising:
enabling the user to add content to a location-based message that the user has accessed.

29. The method of claim 1, further comprising:
enabling the user to add a keyword to a location-based message that the user has accessed that describes the subject matter of the content of the location-based message.

30. The method of claim 1, further comprising:
storing a notification message corresponding to each identified location-based message available to the user, in a user-specific queue; and
enabling the user to sort notification messages according to one or more criteria.

31. The method of claim 30, wherein one criterion by which the user may sort notification messages is according to the identity of the creator of the corresponding location-based messages.

32. The method of claim 30, wherein one criterion by which the user may sort notification messages is according to the subject matter of the content of the corresponding location-based messages.

33. The method of claim 30, wherein one criterion by which the user may sort notification messages is according to a rating of the content of the corresponding location-based messages.

34. The method of claim 30, wherein one criterion by which the user may sort notification messages is according to the date of creation of the corresponding location-based messages.

35. The method of claim 30, wherein one criterion by which the user may sort notification messages is according to the date of access by the user of the corresponding location-based messages.

36. The method of claim 30, wherein one criterion by which the user may sort notification messages is according to one or more keywords identifying the subject matter of the content of the corresponding location-based messages.

37. The method of claim 1, further comprising:
storing each identified location-based message available to the user, in a user-specific queue; and
enabling the user to sort location-based messages according to one or more criteria.

38. The method of claim 37, wherein one criterion by which the user may sort location-based messages is according to the identity of the creator of the location-based messages.

39. The method of claim 37, wherein one criterion by which the user may sort location-based messages is according to the subject matter of the content of the location-based messages.

40. The method of claim 37, wherein one criterion by which the user may sort location-based messages is according to a rating of the content of the location-based messages.

41. The method of claim 37, wherein one criterion by which the user may sort location-based messages is according to the date of creation of the location-based messages.

42. The method of claim 37, wherein one criterion by which the user may sort location-based messages is according to the date of access by the user of the location-based messages.

43. The method of claim 37, wherein one criterion by which the user may sort location-based messages is according to one or more keywords identifying the subject matter of the content of the location-based messages.

44. The method of claim 1, further comprising:
enabling the user to subscribe to a topic-centric collection of location-based messages.

45. The method of claim 1, further comprising:
receiving location identifier data from the user;
receiving content associated with the location identifier data from the user;
creating a location-based message based on the location identifier data and the content; and
storing the location-based message.

46. The method of claim 44, further comprising:
receiving one or more message parameters from the user relating to the location-based message.

47. A system for notifying a user of the availability of accessible content associated with one or more geographic locations located proximal to the user's location, comprising:
means for determining a location of a mobile computing device associated with a user;
means for identifying, based on the determined location and one or more filtering criteria, one or more location-based messages available to the user, wherein a location-based message comprises location identifier data and content associated with the location-identifier data; and
means for transmitting, for each identified location-based message available to the user, a notification message to the user's mobile computing device, wherein a notification message includes information about its corresponding location-based message, as well as a pointer to its corresponding location-based message to enable the user to access the location-based message.
